(19) United States
(12) Patent Application Publication
(10) Pub. No.: US 2011/0241599 A1
(43) Pub. Date: Oct. 6, 2011

(54) SYSTEM INCLUDING A PLURALITY OF MOTORS AND A DRIVE CIRCUIT THEREFOR

(75) Inventors: Masayuki Nashiki, Komaki-shi (JP); Tomokazu Ishikawa, Nagoya (JP)

(73) Assignee: DENSO CORPORATION, Kariya-city (JP)

(21) Appl. No.: 13/078,193

(22) Filed: Apr. 1, 2011

(30) Foreign Application Priority Data
Apr. 1, 2010 (JP) 2010-085417

(51) Int. Cl. H02P 5/685

(52) U.S. Cl. 318/724

(57) ABSTRACT

In a system, a plurality of motors are provided. Each of the plurality of motors has a plurality of phase windings. Each of the plurality of motors is rotated when a unidirectional current is supplied to each of the plurality of phase windings thereof. A motor select unit includes a plurality of selectors connected to the plurality of motors, respectively. The motor select unit selects at least one of the plurality of motors via a corresponding at least one of the selectors. A phase current supplier is connected in series to each of the plurality of selectors. The phase current supplier supplies a direct current as the unidirectional current to each of the plurality of phase windings of the selected at least one of the plurality of motors via a corresponding at least one of the selectors.

### CROSS REFERENCE TO RELATED APPLICATIONS

This application is based on Japanese Patent Application 2010-085417 filed on Apr. 1, 2010. This application claims the benefit of priority from the Japanese Patent Application, so that the descriptions of which are all incorporated herein by reference.

### TECHNICAL FIELD

The present disclosure relates to systems each including a plurality of motors and a drive circuit therefor; these systems are installable in various motor vehicles, such as passenger cars and trucks, various types of industrial equipment, and various home appliances.

### BACKGROUND

Three-phase AC (Alternating Current) motors have been widely used.

FIG. 18 is an axial cross sectional view illustrating a schematic structure of a surface permanent magnet synchronous motor (a brushless motor) as an example of such three-phase AC motors.

The motor illustrated in FIG. 18 is provided with an output shaft 181, a substantially annular rotor core 182, and a pair of N and S poles 187 and 188 of permanent magnets. The motor is also provided with a pair of bearings 183, a substantially annular stator core 184, and a substantially cylindrical inner hollow motor housing 186 with an opening in its axial direction.

The output shaft 181 is fixedly mounted on an inner circumference of the rotor core 182. The output shaft 181 is disposed in the opening of the motor housing 186 such that both ends thereof project from the opening, and the rotor core 182 is installed in the motor housing 186. The output shaft 181 is rotatably supported by the motor housing 186 with the bearings 183. The N and S poles 187 and 188 are, for example, mounted on the outer circumference of the rotor core 182 such that the N and S poles are alternatively arranged in the circumferential direction of the rotor core 182. The rotor core 182 and the N and S poles 187 and 188 of the permanent magnet constitute a rotor of the motor.

The stator core 184 is made up of a plurality of magnetic steel sheets stacked in alignment. The stator core 184 is installed in the motor housing 186 such that its inner circumference is opposite to the outer circumference of the rotor core 182 with an air gap therebetween. Three-phase stator windings are installed in the stator core 184. Ends 185 of the three-phase stator windings are drawn out from the stator core 184. The three-phase stator coils and the stator core constitute a stator.

FIG. 19 is a lateral cross sectional view taken on line AA-AA in FIG. 18. In these FIGS. 18 and 19, a two-pole, 6-slot three-phase permanent magnet synchronous motor is used. In order to simply illustrate the structure of the motor, the hatching of the output shaft 181 is omitted in illustration in FIG. 19.

As each of three-phase stator windings of the synchronous motor illustrated in FIGS. 18 and 19, a concentrated, full pitch winding is used. In FIG. 19, the stator core 184 consists of an annular back yoke and 6 teeth 191, 192, 193, 194, 195, and 196 projecting inwardly and circumferentially arranged at equal pitches therebetween. Spaces between circumferentially adjacent teeth provide 6 slots of the stator core 184. U-, V-, and W-phase stator windings are distributedly arranged in corresponding slots of the stator core 184.

Specifically, a U-phase winding is wound from a slot (197) to a slot (19A), a V-phase winding is wound from a slot (199) to a slot (19C), and a W-phase winding is wound from a slot (19B) to a slot (198). The pitch between the slots in which each of the U-, V-, and W-phase windings is wound is set to 180 electrical degrees. Note that FIGS. 18 and 19 show an example of two-pole motors. Multi-pole motors greater than three poles are normally used. FIGS. 18 and 19 show a concentrated winding wound concentratedly in a pair of slots as an example of each phase winding. In full-pitch motors, a distributed winding wound distributedly in two or more pairs of slots is usually used as each phase winding.

FIG. 20 schematically illustrates the connecting structure of the stator coil (three-phase coils) of the three-phase AC motor set forth above and a three-phase AC inverter (three-phase inverter) for the three-phase AC motor. An example of such three-phase AC inverters is disclosed in Japanese Patent Application Publication No. 2009-247089.

In FIG. 20, reference character 20E represents the U-phase winding, reference character 20F represents the V-phase winding, and reference character 20G represents the W-phase winding.

The three-phase inverter is comprised of a first pair of series-connected high- and low-side power transistors 201 and 202, a second pair of series-connected high- and low-side power transistors 203 and 204, and a third pair of power transistors 205 and 206. Flywheel diodes 207, 208, 209, 20A, 20B, and 20C are connected in antiparallel across the power transistors 201, 202, 203, 204, 205 and 206, respectively. As each power transistor, a power semiconductor element, such as an IGBT and an FET, can be used.

The three-phase inverter is operative to convert a DC voltage supplied from the DC battery 20D into three-phase AC currents Iu, Iv, and Iw, and to supply the three-phase AC currents Iu, Iv, and Iw to the three-phase windings 20E, 20F, and 20G, respectively, thus driving the three-phase motor.

The structure of the three-phase inverter for a three-phase AC motor illustrated in FIG. 20 requires six power transistors to drive the single three-phase AC motor; this increases the cost of the three-phase inverter and a system comprised of the three-phase AC motor and inverter. Specifically, the competitiveness is required for the system comprised of a three-phase AC motor and a three-phase inverter in performance, size, and cost.

A lateral cross section of another conventional motor is illustrated in FIG. 21. The motor illustrated in FIG. 21 is called a “switched reluctance motor”. An example of such switched reluctance motors is disclosed in Japanese Patent Application Publication No. 2002-272071.

The switched reluctance motor is comprised of a substantially annular rotor 21L made up of a plurality of magnetic steel sheets stacked in alignment. The rotor 21L has, at its outer circumferential surface, four salient poles. The four salient poles are circumferentially arranged at regular pitches. The switched reluctance motor also consists of a substantially annular stator 21K with equal-pitched six teeth. There have been many studies of such switched reluctance motors, but a few switched reluctance motors have been put to practical use.

Reference numeral 211 represents a tooth around which an A-phase coil is concentrically wound in positive and negative directions (see reference numerals 217 and 218); this causes the tooth 211 to serve as an A-phase stator pole. The positive direction represents a direction into the paper of FIG. 21, and the negative direction represents a direction out of the paper of FIG. 21.

Reference numeral 214 represents a tooth. As illustrated by a broken line, an A-phase coil is concentrically wound around the tooth 214 in the positive and negative directions (see reference numerals 21E and 21D); this causes the tooth 214 to serve as a negative A-phase stator pole. The A-phase coils are connected to each other in series through a connection wire to provide an A-phase winding.

A group of conductors (wires) in each A-phase coil through each of which a current in the positive direction flows is defined as “a positive A-phase winding”, and a group of conductors (wires) in each A-phase coil through each of which a current in the negative direction flows is defined as “a negative A-phase winding”. That is, reference numerals 217 and 21E represents positive A-phase windings, and reference numerals 218 and 21D represent negative A-phase windings.

When the rotor 21L is presently located as illustrated in FIG. 21, an A-phase current is supplied to flow through each of the positive A-phase windings 217 and 21E in the positive direction, and flow through each of the negative A-phase windings 218 and 21D in the negative direction. This generates a magnetic flux illustrated by an arrow 21M in FIG. 21.

The magnetic flux 21M causes a magnetic attractive force between the A-phase stator pole 211 and one salient pole of the rotor 21L close thereto and between the A-phase stator pole 214 and one salient pole of the rotor 21L close thereto. The attractive force creates a torque to rotate the rotor 21L in counterclockwise direction.

Reference numeral 213 represents a tooth around which a B-phase coil is concentrically wound in the positive and negative directions (see reference numerals 21B and 21C); this causes the tooth 213 to serve as a B-phase stator pole. Reference numeral 216 represents a tooth. As illustrated by a broken line, a B-phase coil is concentrically wound around the tooth 216 in the positive and negative directions (see reference numerals 21J and 21H); this causes the tooth 216 to serve as a negative B-phase stator pole. The B-phase coils are connected to each other in series through a connection wire to provide a B-phase coil member.

Like the A-phase winding, a group of conductors in each B-phase coil through each of which a current in the positive direction flows is defined as “a positive B-phase winding”, and a group of conductors in each B-phase coil through each of which a current in the negative direction flows is defined as “a negative B-phase winding”. That is, reference numerals 21B and 21J represents positive B-phase windings, and reference numerals 21C and 21H represent negative B-phase windings.

Reference numeral 215 represents a tooth around which a C-phase coil is concentrically wound in the positive and negative directions (see reference numerals 21G and 21F); this causes the tooth 215 to serve as a C-phase stator pole. Reference numeral 212 represents a tooth. As illustrated by a broken line, a C-phase coil is concentrically wound around the tooth 212 in the positive and negative directions (see reference numerals 219 and 21A); this causes the tooth 212 to serve as a negative C-phase stator pole. The C-phase coils are connected to each other in series through a connection wire to provide a C-phase coil member.

Like the A- and B-phase windings, a group of conductors in each C-phase coil through each of which a current in the positive direction flows is defined as “a positive C-phase winding”, and a group of C-phase windings in each C-phase coil through each of which a current in the negative direction flows is defined as “a negative C-phase winding”. That is, reference numerals 21G and 219 represents positive C-phase windings, and reference numerals 21F and 21A represent negative C-phase windings.

In the motor illustrated in FIG. 21, the A-phase current, a B-phase current, and a C-phase current are sequentially supplied to the corresponding A-phase, B-phase, and C-phase coils, respectively, according to the rotational position of the rotor 21L relative to the reference position. This creates a continuous torque as a total torque to rotate the rotor 21L.

Simultaneously reversing the direction of the A-phase current flowing through each of the positive A-phase windings and that of the A-phase current flowing through each of the negative A-phase winding maintains unchanged the direction of the created torque because the magnetic attractive force of the soft magnetic material creates the torque. This is established in the B-phase and C-phase currents as well.

The switched reluctance motor illustrated in FIG. 21 has the following features:

The first feature is that the switched reluctance motor is low in cost because it uses no permanent magnets.

The second feature is that, because each of the stator windings is concentratedly wound around a corresponding tooth, the arrangement of individual stator windings is simple.

The third feature is to utilize torque based on high flux density because the magnetic flux acting between the salient poles of the stator and those of the rotor is based on a saturation flux density of the magnetic steel sheets.

The fourth feature is that the rotor can be rotated at a higher RPM because the rotor is rugged.

In the structure of the switched reluctance motor illustrated in FIG. 21, radial force acting between the stator and rotor with rotation of the rotor is changed in direction each time excitation is switched from one pair of opposing teeth to another pair of opposing teeth. This may cause the stator to be deformed in its radial directions, resulting in that the stator may strongly vibrate and/or noise may be produced

In view of the efficiency of excitation of the stator windings, a current is supplied, at a time, to two pairs of one-phase windings, that is, four windings, in six pairs of three-phase windings, that is, twelve windings, to excite them. In other words, the efficiency of excitation of the three-phase stator windings of the switched reluctance motor illustrated in FIG. 21 is 4/12=⅓. Because the stator-winding excitation efficiency of ⅓ is relatively low, this may result in that the amount of heat, such as Joule heat, generated by the excited windings increases.

FIG. 22 illustrates an example of inverters for driving the motor illustrated in FIG. 21.

In FIG. 22, reference character 22D represents the A-phase coil (positive and negative A-phase windings), and reference character 22E represents the B-phase coil (positive and negative B-phase windings). Reference character 22F represents the C-phase coil (positive and negative C-phase windings).

Reference character 20D represents a DC battery 20D. The inverter consists of a first pair of power transistors 221 and 222 between which the A-phase coil is connected, and a second pair of power transistors 223 and 224 between which the B-phase coil is connected. The inverter also consists of a third pair of power transistors 225 and 226 between which the C-phase coil is connected. As power transistors, bipolar transistors are for example used.

A diode 227 is connected in antiparallel to the series-connected transistor 221 and A-phase winding 22D, and a diode 228 is connected in antiparallel to the series-connected transistor 222 and A-phase coil 22D. Similarly, a diode 229 is connected in antiparallel to the series-connected transistor 223 and B-phase coil 22E, and a diode 22A is connected in antiparallel to the series-connected transistor 224 and B-phase coil 22E. In addition, a diode 22B is connected in antiparallel to the series-connected transistor 225 and C-phase coil 22F, and a diode 22C is connected in antiparallel to the series-connected transistor 226 and C-phase coil 22F.

For example, in order to excite the A-phase coil 22D, a driver (not shown) is operative to supply an electric signal to the base of each of the transistors 221 and 222 to turn on the transistors 221 and 222, thus applying a DC voltage supplied from the DC battery 20D to the A-phase coil 22D.

In order to recover magnetic energy created in the A-phase coil 22D during the transistors 221 and 22 being excited, the driver is operative to turn the transistors 221 and 222 off. This allows a regenerative current based on the magnetic energy created in the A-phase coil 22D to flow through the flywheel diode 227, the battery 20D, and the flywheel diode 228. This charges the battery 20D.

At that time, turning on of the transistor 222 with the transistor 221 being off causes a flywheel current to flow through the A-phase coil 22D, the transistor 222, and the diode 228.

The DC-voltage applying control, the magnetic energy recovering control, and the flywheel-current control for the A-phase coil 22D, the transistors 221 and 222, and the diodes 227 and 228 can be carried out for the B-phase coil 22E, the transistors 223 and 224, and the diodes 229 and 22A and for the C-phase coil 22F, the transistors 225 and 226, and the diodes 22B and 22C.

As well as the inverter illustrated in FIG. 20, the inverter illustrated in FIG. 22 requires six power transistors to drive the single switched reluctance motor; this increases the cost of the inverter and the system comprised of the switched reluctance motor and the inverter. Specifically, the competitiveness is required for the system comprised of a switched reluctance motor and an inverter in performance, size, and cost.

### SUMMARY

Motor vehicles require a large number of motors for accessories, such as about thirty motors and one hundred or more motors. In normal drive mode of a motor vehicle, many motors for accessories are deactivated. As it is now, DC motors with low cost are used for motors for accessories, but they have problems in lifetime of their rectifiers, reliability, noise, and size.

On the other hand, blushless motors have a problem of high cost in their inverters.

In view of the circumstances set forth above, an aspect of the present disclosure seeks to provide systems each including a plurality of motors and a drive circuit therefor; each of the systems is designed to have at least one of low cost and small-sized structure.

According to one aspect of the present disclosure, there is provided a system including a plurality of motors. Each of the plurality of motors has a plurality of phase windings. Each of the plurality of motors is rotated when a unidirectional current is supplied to each of the plurality of phase windings thereof. The system includes a motor select unit comprising a plurality of selectors connected to the plurality of motors, respectively. The motor select unit is configured to select at least one of the plurality of motors via a corresponding at least one of the selectors. The system includes a phase current supplier connected in series to each of the plurality of selectors and configured to supply a direct current as the unidirectional current to each of the plurality of phase windings of the selected at least one of the plurality of motors via a corresponding at least one of the selectors.

According to another aspect of the present disclosure, there is provided a system including first and second motors. The first and second motors have a plurality of phase windings. The first and second motors are rotated when a unidirectional current is supplied to the plurality of phase windings thereof. The system includes a first DC power source, and a second DC power source connected to the first DC power source in series. The system includes a plurality of transistors. Each of the plurality of phase windings of the first and second motors is connected to any one of the first and second DC power sources via a corresponding one of the plurality of transistors. The system includes a plurality of diodes connected antiparallel to the plurality of transistors, respectively. The system includes a driver connected to each of the plurality of transistors and configured to: turn on a corresponding one of the plurality of transistors to supply, from a corresponding one of the first and second DC power sources, a direct current as the unidirectional current to one of the plurality of phase windings of the first and second motors; and turn off the corresponding one of the plurality of transistors to transfer magnetic energy charged in the one of the plurality of phase windings to the corresponding one of the first and second DC power sources via a corresponding one of the plurality of diodes.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be constructed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1A is an axial cross sectional view illustrating a schematic structure of a synchronous reluctance motor according to the first embodiment of the present disclosure;

FIG. 1B is a lateral cross sectional view taken on line IB-IB in FIG. 1A;

FIG. 2 is a circuit diagram schematically illustrating an example of a drive circuit according to the first embodiment;

FIG. 3 is a view schematically illustrating operations of the motor illustrated in FIGS. 1A and 1B;

FIG. 4 is a timing chart schematically illustrating an example of exciting patterns for stator windings of the motor illustrated in FIGS. 1A and 1B, and torques created by the excited stator windings;

FIG. 5 is a circuit diagram schematically illustrating an example of a motor system including a drive circuit according to the second embodiment of the present disclosure;

FIG. 6 is a circuit diagram schematically illustrating an example of a motor system including a drive circuit according to the third embodiment of the present disclosure;

FIG. 7 is a circuit diagram schematically illustrating an example of a motor system including a drive circuit according to the fourth embodiment of the present disclosure;

FIG. 8 is a block diagram of a functional structure of a driver of the drive circuit illustrated in FIG. 5 according to the fifth embodiment of the present disclosure;

FIG. 9 is a view schematically illustrating a modification of a DC power source illustrated in each of FIGS. 2, 5, 6, and 7;

FIG. 10 is a lateral cross sectional view schematically illustrating an example of the structure of a reluctance motor according to the sixth embodiment of the present disclosure;

FIG. 11 is a lateral cross sectional view of an alternative example of the structure of a reluctance motor according to the sixth embodiment of the present disclosure;

FIG. 12 is a lateral cross sectional view of a further example of the structure of a reluctance motor according to the sixth embodiment of the present disclosure;

FIG. 13 is a lateral cross sectional view of an example of the structure of a reluctance motor according to the seventh embodiment of the present disclosure;

FIG. 14 is a lateral cross sectional view of an alternative example of the structure of a reluctance motor according to the seventh embodiment of the present disclosure;

FIG. 15 is a view schematically illustrating a stator pole of the motor illustrated in FIG. 14 in an enlarged scale;

FIG. 16 is a perspective view schematically illustrating an example of the structure of a stepping motor that the drive circuit illustrated in FIG. 2, FIG. 5, FIG. 6, or FIG. 7 drives according to the eighth embodiment of the present disclosure;

FIG. 17 is a timing chart schematically illustrating an example of waveforms of currents and voltages to be applied to three-phase windings of the stepping motor illustrated in FIG. 16, and the waveform of a torque created by the three-phase windings;

FIG. 18 is an axial cross sectional view illustrating a schematic structure of a conventional surface permanent magnet synchronous motor;

FIG. 19 is a lateral cross sectional view taken on line AA-AA in FIG. 18;

FIG. 20 is a circuit diagram schematically illustrating a connecting structure of a stator coil (three-phase coils) of the conventional permanent magnet synchronous motor and a control device therefor;

FIG. 21 is a lateral cross sectional view schematically illustrating a conventional switched reluctance motor with a two-pole multi-flux-barrier rotor; and

FIG. 22 is a circuit diagram schematically illustrating a conventional drive circuit.

### DETAILED DESCRIPTION OF EMBODIMENTS

Embodiments of the present disclosure will be described hereinafter with reference to the accompanying drawings. In the drawings, identical reference characters are utilized to identify corresponding identical components. In each embodiment, the present invention is applied to, for example, a reluctance motor as an example of various types of motors.

### First Embodiment

Referring to the drawings, in which like reference characters refer to like parts in several figures, there is illustrated a synchronous reluctance motor 110.

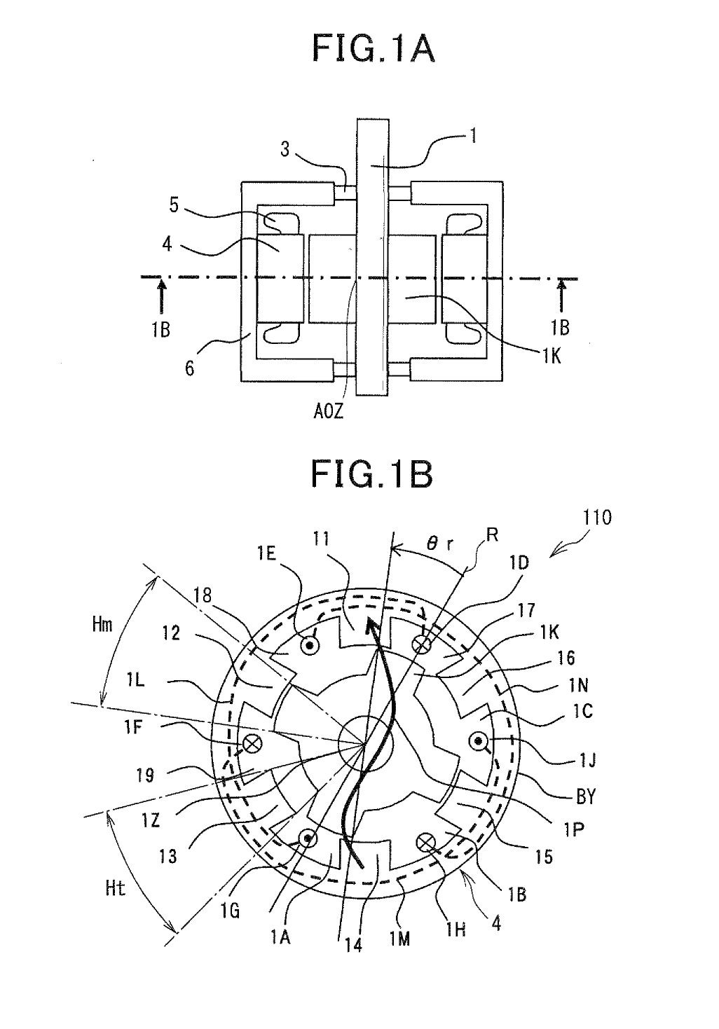

The motor 110 illustrated in FIGS. 1A and 1B is provided with an output shaft 1 and a four salient pole rotor 1K. The motor 110 is also provided with a pair of bearings 3, a substantially annular stator core 4, and a substantially cylindrical inner hollow motor housing 6 with an opening in its axial direction.

The four salient pole rotor, referred to simply as a “rotor”, 1K has a substantially annular shape and a through hole 1Z at its center portion in its axial direction. The rotor 1K is coaxially is installed in the motor housing 6. An axis passing the center portion of the rotor 1K in the axial direction thereof will be referred to as “center axis” hereinafter.

The output shaft 1 is fixedly mounted on the inner surface of the through hole 1Z of the rotor 1K. The output shaft 1 is disposed in the opening of the motor housing 6 such that both ends thereof project from the opening. The output shaft 1 is rotatably supported by the motor housing 6 with the bearings 3.

The rotor 1K is made up of, for example, a plurality of magnetic silicon steel sheets, as an example of soft magnetic materials, stacked in alignment. The rotor 1K is provided with four salient poles. Each of the four salient poles is formed such that its corresponding outer circumference portion radially outwardly projects. Thus, the outer surface of each of the salient poles of the rotor 1K has a convexly circumferentially rounded shape.

The four salient poles consist of first and second pairs of opposing salient poles. The four salient poles are circumferentially arranged at regular pitches.

The stator core 4 is made up of, for example, a plurality of magnetic silicon steel sheets, as an example of soft magnetic materials, stacked in alignment. The stator core 4 is installed in the motor housing 6 such that its center axis is coaxial to the center axis of the rotor 1K and its inner circumference is opposite to the outer circumference of the rotor 1K with an air gap therebetween.

Three-phase stator coils are installed in the stator core 4. The three-phase stator coils and the stator core 4 constitute a stator (stationary member).

Note that, in order to simply illustrate the structure and operations of each motor according to the embodiments of the present invention, hatching is omitted in illustration in some of the accompanying drawings.

Next, the structure of the stator will be fully described with reference to FIG. 1B.

The stator core 4 consists of an annular back yoke BY and six teeth 11, 12, 13, 14, 15, and 16 radially inwardly projecting from the inner circumference of the back yoke BY and circumferentially arranged at equal pitches therebetween. Each of the teeth 11, 12, 13, 14, 15, and 16 serves as a salient pole. The inner surface of each of the teeth (salient poles) has a concavely circumferentially rounded shape with a curvature identical to that of the outer surface of each of the salient poles of the rotor 1K. Spaces between circumferentially adjacent teeth provide 6 slots 17, 18, 19, 1A, 1B, and 1C of the stator core 4.

As each of three-phase stator coils of the motor 110 illustrated in FIGS. 1A and 1B, a concentrated, full pitch winding is used.

An A-phase coil 1D and 1G is concentrically wound in a slot 17 between the teeth 16 and 11 and in a slot 1A between the teeth 13 and 14 at a pitch of 180 electrical degrees. Reference character 1L represents a winding path of an end of the A-phase coil 1D and 1G.

Similarly, a B-phase coil 1F and 1J is concentrically wound in a slot 19 between the teeth 12 and 13 and in a slot 1C between the teeth 15 and 16 at a pitch of 180 electrical degrees. Reference character 1M represents a winding path of an end of the B-phase coil 1F and 1J.

In addition, a C-phase coil 1H and 1E is concentrically wound in a slot 1B between the teeth 14 and 15 and in a slot 18 between the teeth 11 and 12 at a pitch of 180 electrical degrees. Reference character 1N represents a winding path of an end of the C-phase coil 1H and 1E.

In the first embodiment, the motor 110 is driven such that a direct current is supplied to flow through each of the A-, B-, and C-phase coils in positive and negative directions indicated by circled cross and circled dot symbols illustrated in FIG. 1B. The positive direction represents a direction into the paper of FIG. 1B, and the negative direction represents a direction out of the paper of FIG. 1B.

Specifically, a group of conductors in the A-phase coil through which a direct current in the positive direction flows in a slot is defined as “a positive A-phase winding (1D)”, and a group of conductors in the A-phase coil through which a direct current in the negative direction flows in a slot is defined as “a negative A-phase winding (1G)”.

Similarly, a group of conductors in the B-phase coil through which a direct current in the positive direction flows in a slot is defined as “a positive B-phase winding (1F)”, and a group of conductors in the B-phase coil through which a direct current in the negative direction flows in a slot is defined as “a negative B-phase winding (1J)”. In addition, a group of conductors in the C-phase coil through which a direct current in the positive direction flows in a slot is defined as “a positive C-phase winding (1H)”, and a group of conductors in the C-phase coil through which a direct current in the negative direction flows in a slot is defined as “a negative C-phase winding (1E)”.

Each of the coil ends 1L, 1M, and 1N is arranged over a corresponding one half part of the back yoke BY, but can be arranged over each half part of the back yoke BY.

Reference character Ht represents a circumferential electrical angular width of the inner surface of each of the teeth. Reference character Hm represents a circumferential electrical angular width of the outer surface of each of the salient poles of the rotor 1K. Each of the circumferential electrical angular widths Ht and Hm is for example set to be 30 electrical degrees. Note that, in the first embodiment, “circumferential electrical angular width” will also be referred to simply as “circumferential width” hereinafter.

A reference position R illustrated in FIG. 1B is a plane passing through the center of the positive A-phase winding 1D, the center axis of the rotor 1K (output shaft 1), and the center of the negative A-phase winding 1G. A present rotational position of the rotor 1K is represented by θr between one edge of one salient pole leading the rotation of the rotor 1K and the reference position R illustrated in FIG. 1B.

Assuming that a rotational direction of the rotor 1K is set to counterclockwise direction CCW, the rotor 1K is for example presently located close to the rotational angle θr illustrated in FIG. 1B so that one salient pole of the first pair of the rotor 1K starts to face the tooth 11 and the other salient pole of the first pair of the rotor 1K starts to face the tooth 14. The counterclockwise direction CCW will be referred to as “CCW” hereinafter.

At that time, for creating a torque T in the CCW at the rotational position θr, an A-phase current Ia is supplied to flow through the positive A-phase winding 1D (see the circled cross) and negatively flow through the negative A-phase winding 1G (see the circled dot).

Simultaneously, a C-phase current Ic is supplied to positively flow through the positive C-phase winding 1H (see the circled cross) and negatively flow through the negative C-phase winding 1E (see the circled dot).

The A-phase current Ia flowing through the A-phase, coil and the C-phase current Ic flowing through the C-phase coil induce a magnetic flux from the tooth 14 to tooth 11 in accordance with the Ampere's right-handed rule through the rotor 1K; this induced magnetic flux is illustrated in FIG. 1B by thick arrow 1P.

The induced magnetic flux 1P causes a magnetic attractive force between the tooth 11 and the one salient pole of the first pair of the rotor 1K and between the tooth 14 and the other salient pole of the first pair of the rotor 1K. The attractive force creates a torque T in the rotor 1K in the CCW to rotate the rotor 1K therein.

At that time, no current is supplied to flow through the positive and negative B-phase windings 1F and 1J. In addition, no magnetic fluxes are created in directions substantially orthogonal to the magnetic flux 1P, that is, directions toward the stator poles 12 and 13 and toward the stator poles 15 and 16 because a magnetomotive force based on the A-phase current Ia and that based on the C-phase current Ic cancel each other. If the A-phase current Ia and the C-phase current Ic were different in magnitude from each other, magnetic fluxes would be created the directions substantially orthogonal to the magnetic flux 1P because a magnetomotive force proportional to the difference is created.

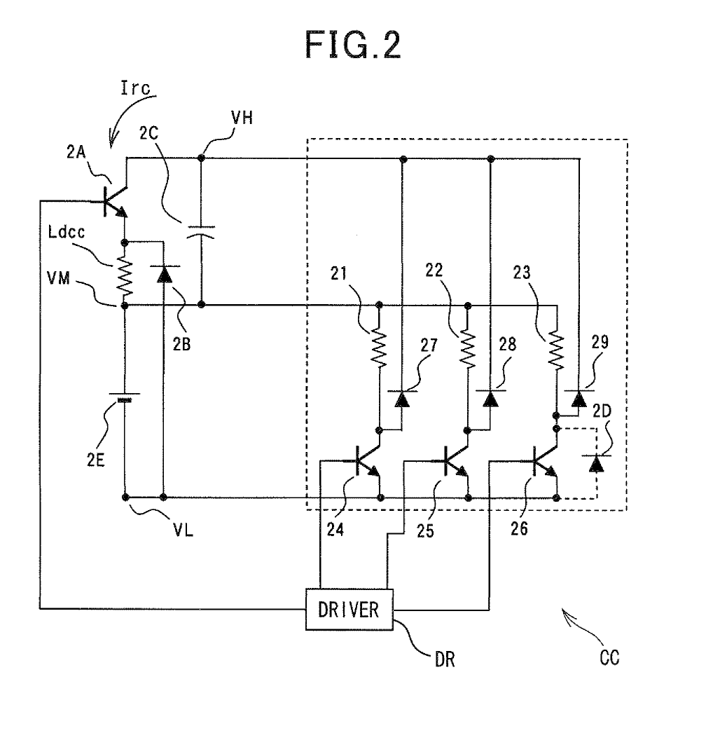

An example of drive circuits for supplying the A-, B-, and C-phase currents Ia, Ib, and Ic to the respective A-, B-, and C-phase coils is illustrated in FIG. 2.

A drive circuit CC illustrated in FIG. 2 is designed as an inverter with a simple structure.

Reference character 21 represents the A-phase coil (positive and negative A-phase windings 1D and 1G), and reference character 22 represents the B-phase coil (positive and negative B-phase windings 1F and 1J). Reference character 23 represents the C-phase coil (positive and negative C-phase windings 1H and 1E).

The drive circuit CC illustrated in FIG. 2 is provided with a DC power source, such as battery 2E, first to third power transistors 24 to 26, and first to third diodes 27 to 29. For example, bipolar transistors are used as the first to third power transistors, referred to simply as “first to third transistors”.

A positive terminal of the battery 2E is connected to the collector of each of the first to third transistors 24 to 26. A negative terminal of the battery 2E is connected to the emitter of each of the first to third transistors 24 to 26. The A- and B-phase coils 21 and 22 are connected between the collector of the transistor 24 and the positive terminal of the battery 2E and between the collector of the transistor 25 and the positive terminal of the battery 2E, respectively. In addition, the C-phase coil 23 is connected between the collector of the transistor 25 and the positive terminal of the battery 2E.

The anode of each of the diodes 27, 28, and 29 is connected to a point at which a corresponding one of the coils 21, 22, and 23 and the collector of a corresponding one of the transistors 24, 25, and 26 are connected to each other.

The drive circuit CC illustrated in FIG. 2 is also provided with a choke coil Ldcc, a fourth transistor, such as a bipolar transistor, 2A, a diode 2B, and a capacitor 2C. One end of the choke coil Ldcc is connected to the positive terminal of the battery 2E, and the other end thereof is connected to the emitter of the fourth transistor 2A.

The cathode of the diode 2B is connected to a point at which the emitter of the transistor 2A and the other end of the choke coil Ldcc are connected to each other. The anode of the diode 2B is connected to the negative terminal of the battery 2E.

The battery 2E, the choke coil Ldcc, and the fourth transistor 2A are connected to each other in series to constitute a series member. The capacitor 2C is parallely connected to the series member. That is, one electrode of the capacitor 2C is connected to the collector of the transistor 2A, and the other electrode of the capacitor 2C is connected to a line between each of the coils 21, 22, and 23 and a connecting point between the one end of the choke coil Ldcc and the positive terminal of the battery 2E.

The collector of the fourth transistor 2A is connected to the cathode of each of the diodes 27, 28, and 29.

The fourth transistor 2A, the choke coil Ldcc, and the diode 2B serve as a DC to DC converter.

The drive circuit CC is provided with a driver DR. The driver DR consisting of, for example, a microcomputer and its peripheries is connected to the base of each of the first to fourth transistors 24, 25, 26, and 2A.

In order to excite the A-phase coil 21, the driver DR supplies an electric signal to the base of the first transistor 24 to turn it on. This allows the A-phase current to flow through the A-phase coil 21 and the first transistor 24 based on a voltage (battery voltage) VM of the battery 2E. Similarly, turning on of each of the second and third transistors 25 and 26 allows a corresponding phase winding to be excited.

For example, when the rotation of the motor is abruptly decelerated, regenerative electric energy is created in each of the stator coils. The regenerative electric energy is taken out through a corresponding one of the diodes 27 to 29 as a regenerative current. The regenerative current charges the capacitor 2C.

The charged voltage in the capacitor 2C is converted by the DC to DC converter into a voltage chargeable in the battery 2E. Thus, the converted voltage is charged in the battery 2E.

Note that the other electrode of the capacitor 2C can be connected to the negative terminal of the battery 2E.

Specifically, the driver DR supplies an electric signal to the control terminal of the fourth transistor 2A to turn it on. This allows the charged voltage in the capacitor 2C to flow a DC current Irc to the choke coil Ldcc. This charges magnetic energy in the choke coil Ldcc. When the driver DR turns the fourth transistor 2A off, the charged magnetic energy causes the current Ire to flow through the diode 2B and the battery 2E to thereby charge the battery 2E. Note that reference character VM represents the voltage of the battery 2E, and reference character VH represents a regenerative voltage based on the regenerative current to be charged in the capacitor 2C.

As described above, the drive circuit CC illustrated in FIG. 2 is operative to obtain regenerative electric power from kinetic energy and magnetic energy of the motor 110 thus efficiently recovering the regenerative electric power in the battery 2E.

Note that the regenerative voltage VH illustrated in FIG. 2 can be set to meet regenerative characteristics of the motor 110 to be required. Particularly, when the motor 110 is to be used at a higher RPM, it is necessary to reduce a current reduction time of each stator winding. Because the reduction in current in a stator winding means the regeneration of magnetic energy created in the stator winding, the higher the regenerative voltage VH is, the more the current reduction time of each stator winding can be reduced.

The structure of the DC to DC converter can be modified. A snubber circuit can be provided in parallel to each transistor for preventing high voltage spikes from damaging a corresponding transistor. A blocking diode, illustrated by an imaginary line as 2D in FIG. 2, can be connected in antiparallel to each of the transistors.

Because the DC to DC converter can be used as a common DC to DC converter for many other motors, if many motors, each of which is driven by the drive circuit CC illustrated in FIG. 2, are used, it is possible to reduce a burden of cost per motor. The motor 110 illustrated in FIGS. 1A and 1B can be driven by the inverter illustrated in FIG. 22.

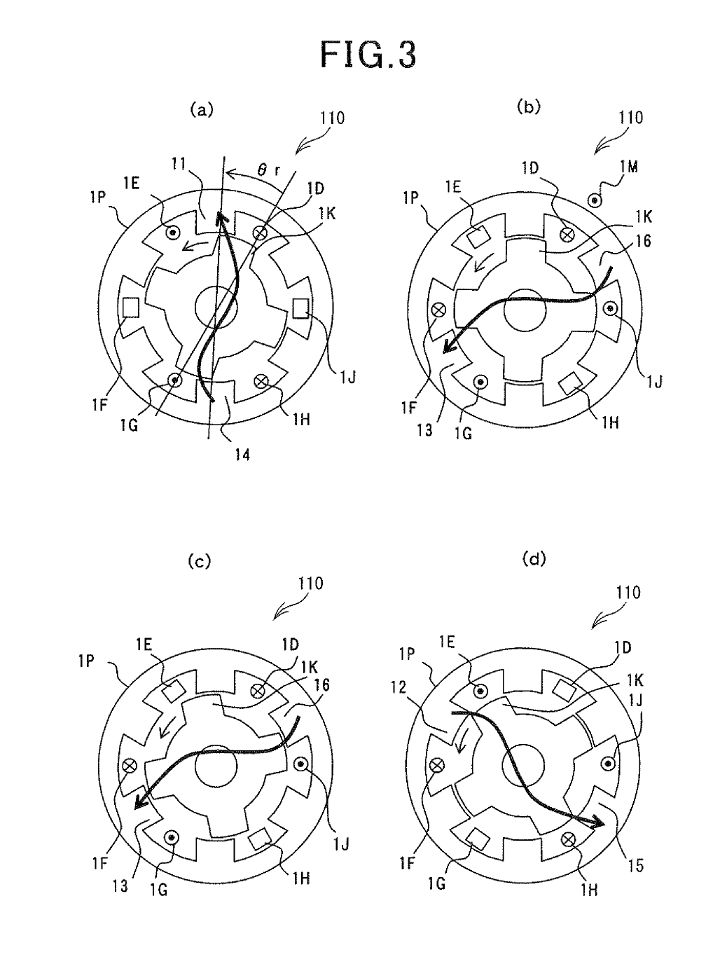

Next, operations of the motor 110 illustrated in FIGS. 1A and 1B will be described hereinafter with reference to (a) to (d) of FIG. 3.

Specifically, when the rotor 1K is presently located close to the rotational angle θ r of 30 degrees illustrated in (a) of FIG. 3 as well as FIG. 1B, one salient pole of the first pair of the rotor 1K starts to face the tooth 11 and the other salient pole of the first pair of the rotor 1K starts to face the tooth 14.

At that time, the A-phase DC current Ia is supplied from the drive circuit CC to positively flow through the positive A-phase winding 1D illustrated by the circled cross and negatively flow through the negative A-phase winding 1G illustrated by the circled dot. Simultaneously, the C-phase DC current Ic is supplied from the drive circuit CC to positively flow through the positive C-phase winding 1H illustrated by the circled cross and negatively flow through the negative C-phase winding 1E illustrated by the circled dot.

The A-phase DC current Ia flowing through the A-phase coil and the C-phase DC current Ie flowing through the C-phase coil induce a magnetic flux from the tooth 14 to tooth 11 illustrated in (a) of FIG. 3 by thick arrow 1P.

The induced magnetic flux 1P causes a magnetic attractive force between the tooth 11 and the one salient pole of the first pair of the rotor 1K and between the tooth 14 and the other salient pole of the first pair of the rotor 1K. The attractive force creates a torque Tin the rotor 1K in the CCW to rotate the rotor 1K therein.

At that time, no DC current is supplied from the drive circuit CC to flow through the B-phase windings 1F and 1J. In addition, no magnetic fluxes are created in directions substantially orthogonal to the magnetic flux 1P, that is, directions toward the stator poles 12 and 13 and toward the stator poles 15 and 16 because a magnetomotive force based on the A-phase DC current Ia and that based on the C-phase DC current Ic cancel each other.

Note that, because the magnetic flux 1P passes through the B-phase coil so that it links the B-phase coil, a voltage Vb is generated across both ends of the B-phase winding; this voltage Vb is given by the following expression:

Vb=Nw×dφ/dt.

where Nw represents the number of turns of the B-phase coil, and φ represents the magnetic flux 1P created by the excited A- and C-phase coils and linking the B-phase coil. Thus, the magnetic flux 1P will be also referred to as “linkage flux φ” hereinafter.

When the rotor 1K is presently located close to the rotational angle θr of 45 degrees illustrated in (b) of FIG. 3, one salient pole of the second pair of the rotor 1K is close to the tooth 13 and the other salient pole of the second pair of the rotor 1K is close to the tooth 16. In addition, one salient pole of the first pair of the rotor 1K faces the tooth 11 and the other salient pole of the first pair of the rotor 1K faces the tooth 14.

At that time, the A-phase DC current Ia is supplied from the drive circuit CC to positively flow through the positive A-phase winding 1D illustrated by the circled cross and negatively flow through the negative A-phase winding 1G illustrated by the circled dot. Simultaneously, the B-phase DC current Ib is supplied from the drive circuit CC to positively flow through the positive B-phase winding 1F illustrated by the circled cross and negatively flow through the negative B-phase winding 1J illustrated by the circled dot.

The A-phase DC current Ia flowing through the A-phase coil and the B-phase DC current Ib flowing through the B-phase coil induce a magnetic flux 1P from the tooth 16 to tooth 13 illustrated in (b) of FIG. 3.

The induced magnetic flux 1P causes a magnetic attractive force between the tooth 13 and the one salient pole of the second pair of the rotor 1K and between the tooth 16 and the other salient pole of the second pair of the rotor 1K. The attractive force creates a torque T in the rotor 1K in the CCW to rotate the rotor 1K therein.

At that time, no DC current is supplied from the drive circuit CC to flow through the C-phase windings 1H and 1E.

When the rotor 1K is presently located close to the rotational angle θr of 60 degrees illustrated in (c) of FIG. 3, one salient pole of the second pair of the rotor 1K faces the tooth 13 and the other salient pole of the second pair of the rotor 1K faces the tooth 16. In addition, one salient pole of the first pair of the rotor 1K faces the tooth 11 and the other salient pole of the first pair of the rotor 1K faces the tooth 14.

At that time, the A-phase DC current Ia is supplied from the drive circuit CC to positively flow through the positive A-phase winding 1D illustrated by the circled cross and negatively flow through the negative A-phase winding 1G illustrated by the circled dot. Simultaneously, the B-phase DC current Ib is supplied from the drive circuit CC to positively flow through the positive B-phase winding 1F illustrated by the circled cross and negatively flow through the negative B-phase winding 1J illustrated by the circled dot.

The A-phase DC current Ia flowing through the A-phase coil and the B-phase DC current Ib flowing through the B-phase coil induce a magnetic flux 1P from the tooth 16 to tooth 13 illustrated in (c) of FIG. 3.

The induced magnetic flux 1P causes a magnetic attractive force between the tooth 13 and the one salient pole of the second pair of the rotor 1K and between the tooth 16 and the other salient pole of the second pair of the rotor 1K. The attractive force creates a torque T in the rotor 1K in the CCW to rotate the rotor 1K therein.

At that time, no DC current is supplied from the drive circuit CC to flow through the C-phase windings 1H and 1E.

When the rotor 1K is presently located close to the rotational angle θ r of 75 degrees illustrated in (d) of FIG. 3, one salient pole of the first pair of the rotor 1K is close to the tooth 12 and the other salient pole of the first pair of the rotor 1K is close to the tooth 15. In addition, one salient pole of the second pair of the rotor 1K faces the tooth 13 and the other salient pole of the second pair of the rotor 1K faces the tooth 16.

At that time, the B-phase DC current Ib is supplied from the drive circuit CC to positively flow through the positive B-phase winding 1F illustrated by the circled cross and negatively flow through the negative B-phase winding 1J illustrated by the circled dot. Simultaneously, the C-phase DC current Ic is supplied from the drive circuit CC to positively flow through the positive C-phase winding 1H illustrated by the circled cross and negatively flow through the negative C-phase winding 1E illustrated by the circled dot.

The B-phase DC current Ib flowing through the B-phase coil and the C-phase DC current Ic flowing through the C-phase coil induce a magnetic flux 1P from the tooth 12 to tooth 15 illustrated in (d) of FIG. 3.

The induced magnetic flux 1P causes a magnetic attractive force between the tooth 12 and the one salient pole of the first pair of the rotor 1K and between the tooth 15 and the other salient pole of the first pair of the rotor 1K. The attractive force creates a torque T in the rotor 1K in the CCW to rotate the rotor 1K therein.

At that time, no DC current is supplied from the drive circuit CC to flow through the A-phase windings 1D and 1G.

As illustrated in FIG. 3, switching the A-, B-, and C-phase currents Ia, Ib, and Ic from one another depending upon the rotational position θr of the rotor 1K under control of the drive circuit CC achieves a continuous torque to continuously rotate the rotor 1K. As described above, the supply of one pair in the previously directed DC currents Ia, Ib, and Ic to a corresponding one pair of stator coils generates the magnetic flux 1P to thereby generate a torque T; this one pair of the stator coils is located at both circumferential sides of each stator pole magnetically attracting a corresponding one rotor pole.

Specifically, the motor 110 according to the first embodiment has a feature that each of the currents Ia, Ib, and Ic is an one-way (unidirectional) current and each of the stator coils and a corresponding one current contribute to two different electromagnetic actions. In addition, two-phase stator coils serve as two individual paths through which power is supplied.

Because each stator winding serves to drive corresponding two stator poles at its both circumferential sides, in other words, each stator coil serves to drive corresponding four stator poles, each power transistor serves to drive corresponding four stator poles. For example, the A-phase stator coil serves to drive four stator poles 11, 17, 14, and 13. Reluctance torque, which is created by the motor 110 according to the first embodiment, efficiently utilizes one-directional attractive force independently of the direction of the magnetic flux.

These characteristics of the motor 110 according to the first embodiment can reduce the motor 110 in size, and reduce the current capacity of each power transistor of the drive circuit CC. These characteristics can be applied to other types of motors described later.

Switching, by the drive circuit CC, the A-, B-, and C-phase currents Ia, Ib, and Ic from one another depending upon the rotational position θr of the rotor 2 allows the rotor 1K to continuously rotate. Change of the direction of each of the A-, B-, and C-phase currents Ia, Ib, and Ic allows the rotor 2 to turn in the CCW and clockwise direction CW. In addition, the reluctance motor 110 can be driven in power running mode in which the rotational direction and the torque direction are identical to each other, and in regeneration mode in which the rotational direction and the torque direction are opposite to each other. The clockwise direction will be referred to simply as “CW” hereinafter.

Note that the motor 110 according to the first embodiment can be driven by a bidirectional current controller for bidirectionally supplying a current to each of the stator coils, and therefore, such bidirectional current controller for individually exciting the stator coils can be included within the scope of the present invention. As described later, in some types of motors, supplying positive and negative currents to each of the stator windings can improve the average output torques, the peak output torques, and the constant-output characteristics of these motors.

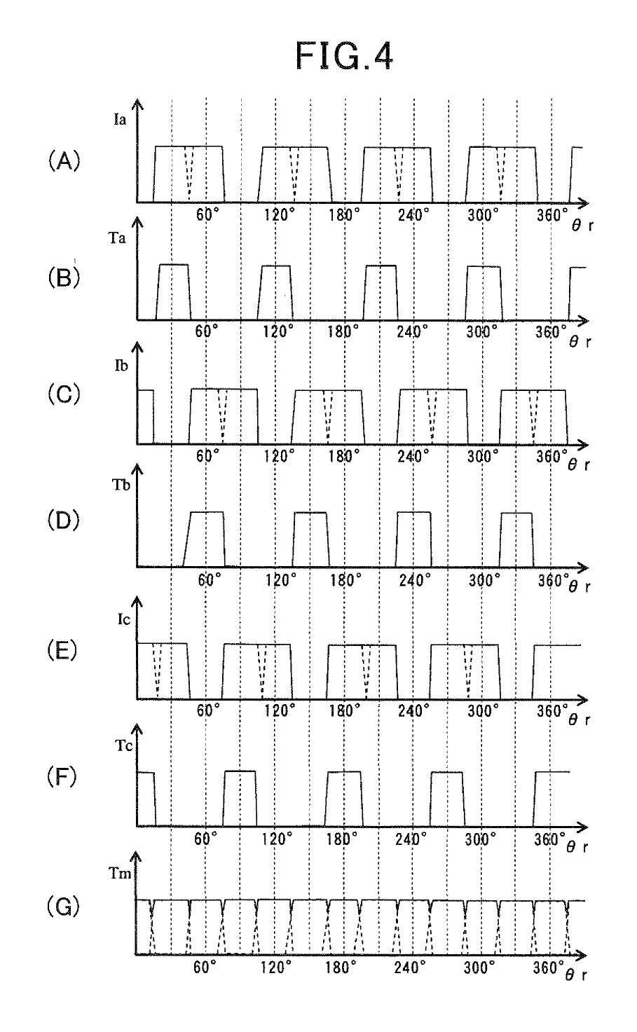

As illustrated in FIG. 4, switching, by the drive circuit CC, the A-, B-, and C-phase currents Ia, Ib, and Ic from one another depending upon the rotational position θr of the rotor 1K in accordance with the exciting pattern illustrated in FIG. 4 allows the rotor 1K to continuously rotate. Change of the direction of each of the A-, B-, and C-phase currents Ia, Ib, and Ic allows the rotor 1K to turn in the CCW and clockwise direction CW. In addition, the reluctance motor 110 can be driven in power running mode in which the rotational direction and the torque direction are identical to each other, and in regeneration mode in which the rotational direction and the torque direction are opposite to each other. The clockwise direction will be referred to simply as “CW” hereinafter.

FIG. 4 schematically illustrates an example of exciting patterns (current supply patterns) for the stator windings in a transitional range of the rotational position θr in a range from 0 to 360 electrical degrees. FIG. 4 also illustrates torques created by exciting the stator windings in accordance with the example of the exciting patterns in the transitional range of the rotational position θr.

Specifically, (A) of FIG. 4 illustrates, by solid line, an excitation pattern (a pattern of supplying the A-phase current Ia) for the A-phase windings by the drive circuit CC, and (C) of FIG. 4 illustrates, by solid line, an excitation pattern (a pattern of supplying the B-phase current Ib) for the B-phase windings by the drive circuit CC. In addition, (E) of FIG. 4 illustrates, by solid line, an excitation pattern (a pattern of supplying the C-phase current Ic) for the C-phase windings by the drive circuit CC.

(B) of FIG. 4 shows a torque Ta to be given to the rotor 1K from the stator poles 11 and 14 illustrated in (a) of FIG. 3, and (D) of FIG. 4 shows a torque Tb to be given to the rotor 1K from the stator poles 13 and 16 illustrated in (b) and (c) of FIG. 3. (F) of FIG. 4 shows a torque Tc to be given to the rotor 1K from the stator poles 12 and 15 illustrated in (d) of FIG. 3.

(G) of FIG. 4 shows a transition of a continuous torque Tm for rotation of the rotor 1K by making connections between the created torques Ta, Tb, and Tc by solid line.

The motor 110 illustrated in FIG. 1B is designed such that the circumferential electrical angular width Ht of the inner surface of each tooth and the circumferential electrical angular width Hm of the outer surface of each salient pole 1K of the rotor 1K are each set to 30 electrical degrees. That is, because the number (M) of the stator poles is 6, the circumferential electrical angular width Ht of the inner surface of each of the teeth can be calculated by the following equation:

Ht=360/(6×2)=30 electrical degrees.

For this reason, when a torque created by a corresponding pair of stator poles excited by a corresponding phase current is shifted to another torque to be created by a corresponding alternative pair of stator poles excited by a corresponding alternative phase current, the continuous torque Tm is reduced. An increase in each of the circumferential electrical angular width of the inner surface of each tooth and that of the outer surface of each salient pole 1K of the rotor 1K from an electric angle of 30 degrees can reduce the drop in the torque Tm at a torque shift in the continuous torque Tm.

A basic example of how to drive the reluctance motor 110 illustrated in FIG. 1B is illustrated in FIG. 4, but the present disclosure is not limited to the example. Specifically, adjustment of the phase and/or the magnitude of each phase current can more efficiently drive the reluctance motor 110. For example, advance of the phase of each phase current can efficiently address a delay in current-increase and current-reduction responses during high-speed rotation of the motor.

Even if the same current is supplied to flow through one pair of two-phase stator coils, the magnitude of the magnetic flux φ is changed with change in the rotational position of the rotor 1K so that the magnetic energy is changed. In addition, a voltage is induced across both ends of each stator winding as the rotor 1K is turned. Thus, an application of a voltage to one phase coil in an electrical angular range during which no voltage is induced across the one phase coil and a small magnetic energy is stored therein can speed up the increase in one phase current flowing through the one phase coil. For this reason, advance of the phase of each phase current can effectively address a delay in current-increase and current-reduction responses.

In order to apply a proper voltage to each phase coil at a proper timing, the flux linkage by each phase coil is estimated, and, based on the estimated flux linkage by each phase coil, the proper voltage to be applied to a corresponding one phase winding is calculated. Then, the calculated proper voltage can be applied to each phase coil in feedforward control. This can properly control each phase current at a high response. The feedforward control method set forth above will be described later.

The supply of one phase current to a corresponding phase winding in one direction and an alternative one phase current to a corresponding alternative phase winding circumferentially adjacent to each other via one stator pole in a direction opposite to the one direction creates a magnetic flux by the one stator pole. One phase current to a corresponding phase winding and an alter native one phase current to a corresponding alternative phase winding circumferentially adjacent to each other via one stator pole can be different in magnitude from each other. A current can be simultaneously supplied to flow through each of the three-phase stator coils.

The example of the exciting pattern for the A-phase coil illustrated in (A) of FIG. 4 is designed such that:
a constant value of the A-phase current Ia is supplied to the A-phase coil during the rotation of the rotor 1K from its rotational position of 15 degrees to that of 75 degrees in a first mode;

no current is supplied to the A-phase coil during the rotation of the rotor 1K from its rotational position of 75 degrees to that of 105 degrees in a second mode; and
the first and second modes are cyclically repeated.

The example of the exciting pattern for the B-phase coil illustrated in (C) of FIG. 4 is designed such that the B-phase current Ib to be supplied to the B-phase coil is delayed in phase of 30 electrical degrees from the A-phase current Ia. The example of the exciting pattern for the C-phase winding illustrated in (E) of FIG. 4 is designed such that the C-phase current Ic to be supplied to the C-phase coil is delayed in phase of 30 electrical degrees from the B-phase current Ib.

The drive circuit CC is designed to simultaneously supply two phase currents to the corresponding two phase coils, and to reduce one phase current with increase in another one phase current.

An alternative example of the exciting patterns for the three-phase stator coils is illustrated by combinations of solid and dashed lines in FIG. 4.

Specifically, each of the A-phase current Ia and the C-phase current Ic to be supplied to a corresponding one of the A- and C-phase coils is increased from zero to a constant level at the rotor's rotational position of 15 degrees. Each of the A-phase current Ia and the C-phase current Ic to be supplied to a corresponding one of the A- and C-phase coils is reduced to zero at the rotor's rotational position of 45 degrees. Immediately thereafter, each of the B-phase current Ib and the A-phase current Ia to be supplied to a corresponding one of the B- and A-phase coils is increased from zero to a constant level.

Each of the B-phase current Ib and the A-phase current Ia to be supplied to a corresponding one of the B- and A-phase coils is reduced to zero at the rotor's rotational position of 75 degrees. Immediately thereafter, each of the C-phase current Ic and the B-phase current Ib to be supplied to a corresponding one of the C- and B-phase coils is increased from zero to a constant level.

Each of the C-phase current Ic and the B-phase current Ib to be supplied to a corresponding one of the C- and B-phase coils is reduced to zero at the rotor's rotational position of 105 degrees. Immediately thereafter, each of the A-phase current Ia and the C-phase current Ic to be supplied to a corresponding one of the A- and C-phase coils is increased from zero to a constant level.

Each of the A-phase current Ia and the C-phase current Ic to be supplied to a corresponding one of the A- and C-phase coils is reduced to zero at the rotor's rotational position of 135 degrees.

The winding exciting sequence set forth above is cyclically repeated to thereby turn the rotor 1K in the CCW by a constant torque.

The alternative example of the exciting patterns for the three-phase stator coils induces a desired directed magnetic flux. Note that the transient reduction in each phase current illustrated by the solid lines in FIG. 4 is not required to zero. Specifically, the transient reduction in each phase current to a preset level can achieve the advantage set forth above. In order to increase the responsivity of each phase current at an RPM of the rotor 1K higher than a present RPM, the phase of each phase current can be advanced from the phase thereof illustrated in FIG. 4.

As a further example of the exciting patterns for the three-phase stator coils, when only one phase coil is energized, a magnetic flux is induced in each of two paths. In addition, when currents are simultaneously supplied to the three-phase stator coils, it is possible to produce various electromagnetic actions based on a combination of the magnitudes of the respective currents. It is also possible to combine the various electromagnetic actions with one another to thereby create desired torques.

When the motor 110 being rotated in the CCW is braked, such as when regenerative braking is applied to the motor 110 being rotated in the CCW, operations of the drive circuit CC can be carried out in a similar approach illustrated in FIG. 4.

As described above, the reluctance motor 110 illustrated in FIGS. 1A and 1B according to the first embodiment has:

a first feature of supplying a DC current to each of the three-phase stator coils;

a second feature of making each phase winding serve to drive two stator poles located at both sides of a corresponding phase winding; and

a third feature that an increase and decrease in a DC current to be supplied to each of the stator coils allows the motor 110 to be driven in four quadrant drive.

Specifically, in the third feature, the motor 110 can be designed to turn the rotor 2 in the CCW and the CW, and designed such that a power running torque or a regeneration torque is applied to the rotor 2.

These features reduce, in size, an inverter of the drive circuit CC illustrated in FIG. 2 in closely cooperation with the structure of the motor 110 and the structure of the drive circuit CC.

Let us use the drive circuit CC illustrated in FIG. 2 and describe the reduction of the inverter in size.

It is assumed that a voltage of the battery 2E is set to 200 [volts; V], and a current capacitance of each power transistor is set to 10 [amperes; A]. When the rotor 2 reaches the rotational angle θr of 30 degrees illustrated in (a) of FIG. 3, it is also assumed that the A-phase current of 10 [A] is supplied to the A-phase coil 1D and 1G (21 in FIG. 2), and the C-phase current of 10 [A] is supplied to the C-phase coil 1H and 1E (23 in FIG. 2).

At that time, as illustrated in (a) of FIG. 3, a flux linkage φ created by the excited A-phase stator winding and that created by the excited A-phase stator winding are identical to each other, and therefore, the flux-linkage change rate dφ/dθr with change in the rotational position of the rotor 2 based on the excited A-phase winding is identical to that based on the excited C-phase winding.

It is also assumed that a voltage across each of the excited A-phase stator winding and the C-phase stator winding is assumed to be set to 200 [V].

At that time, output power P1 from the inverter of the drive circuit CC, which is input power to the motor 110, is given by the following equation:

P1=(200 V)×(100 V)×N (1)

where N represents the number of A- and C-phase stator windings.

Thus, the equation (1) is represented as follows:

P1=4000 [W]

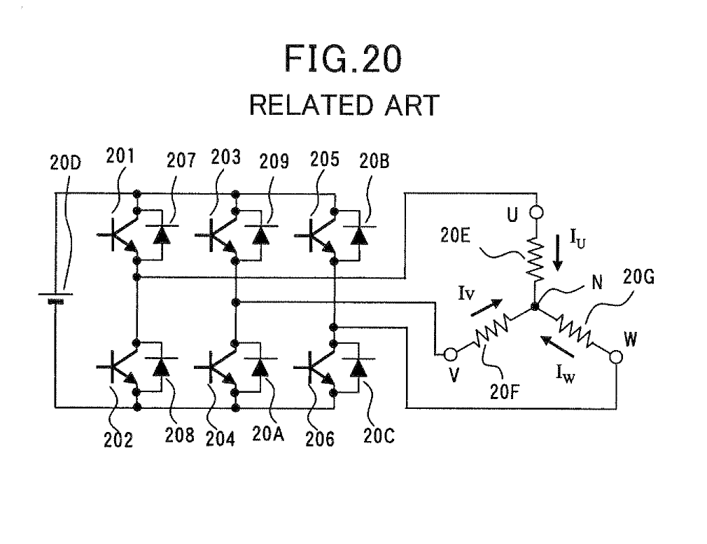

On the other hand, the conventional three-phase inverter illustrated in FIG. 20 has been frequently used. Next, let us examine maximum output power from the conventional three-phase inverter to which star-connected three-phase stator windings of a three-phase AC motor are connected. In the examination, it is assumed that a voltage of the battery 20D is set to 200 [V], and a current capacitance of each power transistor of the conventional three-phase inverter is set to 10 [A]. Assuming that a voltage of 200 [V] is applied between the U-phase winding 20E and the V-phase winding 20F, and a maximum current of 10 [A] is supplied from the U-phase winding to the V-phase winding, output power P2 from the inverter of the conventional three-phase inverter is given by the following equation:

$$\begin{matrix}P 2 = ( 200 V ) \times ( 10 A ) \\ = 2000 [ W ]\end{matrix} \qquad ( 2 )$$

Note that, when the half of a current is supplied from the U-phase winding to the V-phase winding, and the remaining of the current is supplied from the U-phase winding to the W-phase winding, output power of the inverter equivalent to the output power P2 can be obtained.

Specifically, in the drive circuit illustrated in FIG. 20, when an induced voltage in each stator winding becomes a value close to the voltage of the battery 20D and a three-phase sinusoidal current is supplied to the three-phase stator windings so that a peak current of the three-phase sinusoidal current is substantially equivalent to a maximum current through each power transistor, output power of the motor equivalent to the output power P2 can be obtained independently of the phase of each of the three-phase sinusoidal currents.

In a first motor system consisting of the motor 110 illustrated in FIG. 1B and the drive circuit CC illustrated in FIG. 2, using only three power transistors achieves the output power of 4000 [W] of the drive circuit CC. In contrast, in a second motor system consisting of a normal three-phase AC motor and the three-phase inverter illustrated in FIG. 20, using six power transistors achieves the output power of 2000 [W] of the three-phase inverter. When comparing output power per one power transistor between the first and second motor systems, the output power per one power transistor of the first motor system is four times greater than that per one power transistor of the second motor system.

When comparing the first and second motor systems in the same output power conditions, the drive circuit CC illustrated in FIG. 2 requires three power transistors that is the half of the number of power transistors required by the second motor system. In addition, the current capacitance of each power transistor of the first motor system is the half (5 A) of that of each power transistor of the second motor system. In other words, the first motor system provided with three power transistors each having the current capacitance of 5 [A] can output 2000 [W] that can be outputted by the second motor system provided with six power transistors each having the current capacitance of 10 [A].

Note that the drive circuit CC illustrated in FIG. 2 requires the DC to DC converter consisting of the transistor 2A, and a breakdown voltage of the transistor 2A is set to be higher than 200 [V].

In automobiles using a battery voltage of 12 [V], 50 to 100 or more motors for accessories have been installed in each automobile. In these applications, the DC to DC converter of the drive circuit CC illustrated in FIG. 2 can be shared between the plurality of motors. In this case, each of the plurality of motors can be driven by the drive circuit CC consisting of three power transistors. Thus, in comparison to the structure that a plurality of drive circuits illustrated in FIG. 20 is used for the respective motors, it is possible to simplify the structure of the drive circuit CC illustrated in FIG. 2.

In motor vehicle, such as electric vehicles and/or hybrid vehicles, two or more motors have been frequently used to create drive power for the drive shaft. Normally, in automobiles, their fuel economies, such as the efficiencies of driving their motors, are important in fuel consumption test modes, such as Japanese 10-15 mode test, and US Urban Dynamometer Driving Schedule (UDDS) cycle.

In many fuel consumption test modes, the efficiency of driving a motor used in a target automobile is set to be equal to or lower than the half of a maximum torque of the motor. Thus, a generation capacity by a motor of the target automobile during regeneration, in other words, a regeneration capacity by the motor is set to be sufficiently equal to or lower than the half of maximum output capacitance of the motor. If the target automobile should be suddenly decelerated, a mechanical brake system could be used together with the regenerative braking set forth above in view of safety.

From the viewpoint set forth above, the DC to DC converter illustrated in FIG. 2 can be shared by a plurality of motors, and a drive circuit for driving one motor can be considered as a circuit consisting of three power transistors 24, 25, and 26 and three diodes 27, 28, and 29 (see FIG. 2). Thus, an inverter illustrated by dashed lines in FIG. 2 is designed as a simple inverter consisting of three transistors and three diodes for driving one motor, and therefore, the inverter illustrated in FIG. 2 can be lower in cost.

In addition, the sum of the forward voltage drops in the inverter illustrated in FIG. 2 is substantially the half of that of the forward voltage drops in the inverter illustrated in FIG. 20. Similarly, the sum of the voltage drops across the diodes of the inverter illustrated in FIG. 2 during regeneration is substantially the half of that of the voltage drops across the diodes of the inverter illustrated in FIG. 20.

This improves the efficiency of the inverter and reduces the heat to be generated by the inverter, thus reducing the inverter illustrated in FIG. 2 in size.

Next, let us describe a case where the inverter illustrated in FIG. 22 is used to drive the motor 110 illustrated in FIG. 1B.

It is assumed that a voltage of the battery 22D is set to 200 [V], and a current capacitance of each power transistor is set to 10 [A].

When a maximum voltage and a maximum current of 10 [A] are applied to the A-phase coil 1D and 1G (22D in FIG. 22), and a maximum voltage and a maximum current of 10 [A] are applied to the C-phase coil 1H and 1E (22F in FIG. 22), maximum output power P3 of the inverter illustrated in FIG. 22, which is input power to the motor 110, is given by the following equation:

P1=(200 V)×(100 V)×N (3)

where N represents the number of A- and C-phase stator coils.

Thus, the equation (3) is represented as follows:

P1=4000 [W]

A third motor system consisting of the motor 110 illustrated in FIG. 1B and the inverter illustrated in FIG. 22 achieves the output power of 4000 [W] of the inverter. In contrast, as described above, the second motor system consisting of a normal three-phase AC motor and the three-phase inverter illustrated in FIG. 20 achieves the output power of 2000 [W] of the three-phase inverter. Thus, the output power of the third motor system is two times greater than that of the second motor system.

When comparing the third and second motor systems in the same output power conditions, the current capacitance of each power transistor of the third motor system is the half (5 A) of that of each power transistor of the second motor system. In other words, the third motor system provided with six power transistors each having the current capacitance of 5 [A] can output 2000 [W] that can be outputted by the second motor system provided with six power transistors each having the current capacitance of 10 [A].

Therefore, the third motor system can be lower in cost as compared with the second motor system.

As described above, the first and third motor system according to the first embodiment are each designed to reduce the current capacitance of the inverter to substantially the half of conventional three-phase inverters; these first and third motor systems are therefore new and rendered unobvious from conventional motor systems.

Note that such motor systems according to the first embodiment include the technical disclosures of the U.S. patent application Ser. No. 12/617,973. In other words, the technical disclosures of the U.S. patent application Ser. No. 12/617,973 are incorporated herein by reference because the U.S. patent application Ser. No. 12/617,973 is assigned to the same assignee as that of this application.

The present disclosure seeks to further reduce, in cost and size, motor systems including a plurality of motors each driven on DC power, such as the motor 110 according to the first embodiment.

### Second Embodiment

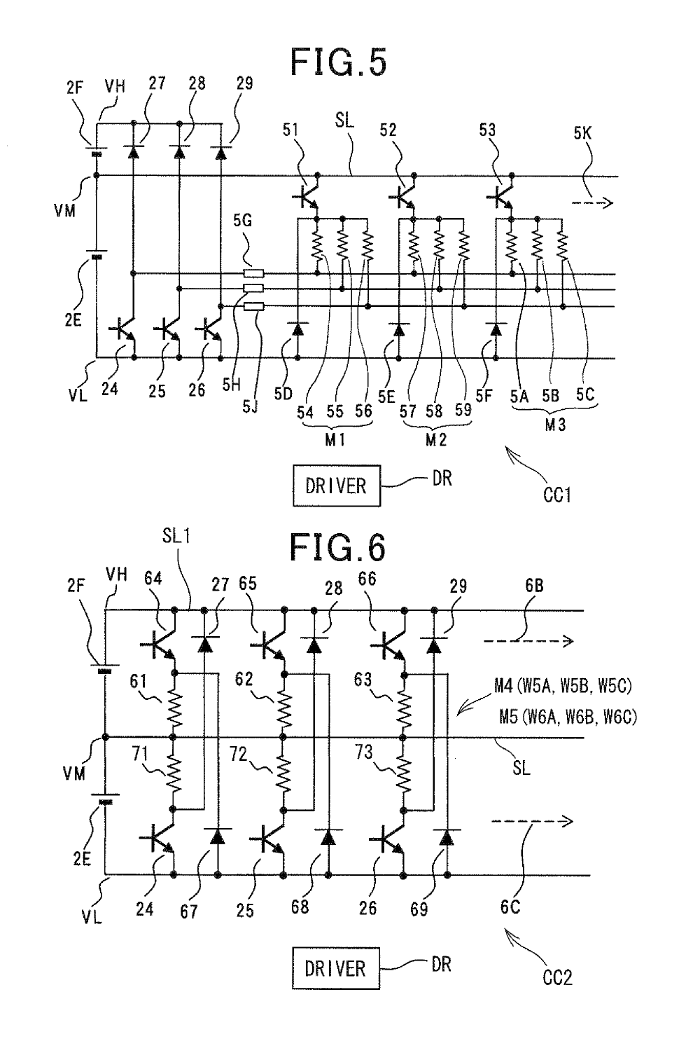

A motor system according to the second embodiment of the present disclosure will be described hereinafter with reference to FIG. 5.

The motor system illustrated in FIG. 5 includes three motors M1 to M3 driven on DC power, for example, each of which is designed as the motor 110. The motor system also includes a drive circuit CC1 for driving the three motors M1, M2, and M3.

The structure and/or functions of the drive circuit CC1 according to the second embodiment are different from the drive circuit CC by the following points. So, the different points will be mainly described hereinafter.

Reference character 2F is a DC power source like the DC power source 2E; these DC power sources 2E and 2F are, for example, batteries for motor vehicles. A positive terminal of the battery 2E is connected to a negative terminal of the battery 2F at a connecting point to which a power supply line SL is connected. In other words, the DC power sources 2E and 2F are connected in series with each other. The motor M1 includes three coils 54, 55, and 56 corresponding to the A-, B-, and C-phase coils 21, 22, and 23, respectively, through which a unidirectional current, that is, a DC current is supplied to flow. Specifically, the coil 54 is comprised of the positive and negative A-phase windings 1D and 1G, the coil 55 is comprised of the positive and negative B-phase windings 1F and 1J, and the coil 56 is comprised of the positive and negative C-phase windings 1H and 1E. Similarly, the motor M2 includes three coils 57, 58, and 59 corresponding to the A-, B-, and C-phase coils 21, 22, and 23, respectively, and the motor M3 includes three coils 5A, 5B, and 5C corresponding to the A-, B-, and C-phase coils 21, 22, and 23, respectively.

Reference characters 51, 52, and 53 represent bipolar transistors (transistors), which are an example of N power suppliers (selectors) ST (N is an integer greater than 1). The collector of each of the transistors 51 to 53 is connected to the power supply line SL, and the emitter of each of the transistors 51 to 53 is connected to a corresponding one of the motors M1 to M3. The base (conduction control terminal) of each of the transistors 51 to 53 is connected to the driver DR (connections therebetween are not illustrated in FIG. 5 for simplicity of descriptions). The driver DR and the transistors 51 to 53 allow selection of any one of the motors M1 to M3 to be driven. For example, when driving the motor M1, the driver DR supplies a drive signal to the gate of the transistor 51 to turn it on with the transistors 52 and 53 being off, resulting in that DC power is supplied through the power supply line SL and the transistor 51 to the motor M1. How to specifically supply current to the motor M1 has been described in the first embodiment.

Reference characters 5G, 5H, and 5J represent current sensors. The current sensor 5G is connected between each of the coils 54, 57, and 5A and a connecting point between the emitter of the transistor 24 and the anode of the diode 27, the current sensor 5H is connected between the emitter of the transistor 25 and the anode of the diode 28, and the current sensor 5J is connected between the emitter of the transistor 26 and the anode of the diode 29. The collector of each of the transistors 24, 25, and 26 is connected to the negative terminal of the battery 2E. The base of each of the transistors 24, 25, and 26 is connected to the driver DR (connections therebetween are not illustrated in FIG. 5 for simplicity of descriptions).

In other words, each of the transistors 51, 52, and 53 is connected in series to a corresponding one of the transistors 24, 25, and 26.

Each of the current sensors 5G, 5H, and 5J is connected to the driver DR (connections therebetween are not illustrated in FIG. 5 for simplicity of descriptions), and operative to measure a corresponding one of A-, B-, and C-phase currents I1a, I1b, and I1c.

Specifically, each of the transistors 24, 25, and 26 is an example of a phase-current applier operative to apply a corresponding one of the A-, B-, and C-phase currents I1a, I1b, and I1c to a corresponding one phase winding of each of the motors M1, M2, and M3. As described in the first embodiment, the cathode of each of the diodes 27, 28, and 29 is connected to the positive terminal of the battery 2F, and the anode of each of the diodes 27, 28, and 29 is connected to the collector of a corresponding one of the transistors 24, 25, and 26.

Specifically, when the transistors 24, 25, and 26 are switched from on state to off state, the diodes 27, 28, and 29 allow the A-, B-, and C-phase currents I1a, I1b, and I1c to flow to the battery 2F based on regenerative electric energy charged in the corresponding coils, respectively, resulting in that the battery 2F is charged.

For example, when the transistor 24 is turned on with the transistor 51 being in on state, the A-phase current I1a starts to flow through the coil 54. Thereafter, when the transistor 24 is turned off, regenerative electric energy charged in the coil 54 and part of kinetic energy created in the coil 54 create regenerative current, and the regenerative current is transferred through the diode 27 to be supplied to the battery 2F, resulting in that the battery 2F is charged.

Reference character 5D is an overvoltage protective diode whose anode is connected to the negative terminal of the battery 2E and whose cathode is connected to each of the coils 54, 55, and 56. The overvoltage protective diode 5D allows an overvoltage applied when the transistor 51 is turned off with any one of the A-, B-, and C-phase currents flowing through a corresponding one of the motors M1, M2, and M3 to be transferred therethrough, resulting in protection of the transistor 51. Thus, the overvoltage protective diode 5D cannot be provided if the transistor 51 is controlled not to be switched from on to off with any one of the A-, B-, and C-phase currents flowing through a corresponding one of the coils 54, 55, and 56. The overvoltage protective diode 5D can be replaced with another overvoltage protective element.

The overvoltage protective diode 5D also serves to speed up the removal of current (charges) from the transistor 51 and any one of the transistors 24 to 26. This is effective in controlling large current at the motor M1 with high speed revolution. For example, when the transistors 51 and 24 are switched from on to off with the A-phase current I1a flowing through the motor M1, the A-phase current I1a based on the charges remaining in each of the transistors 51 and 24 immediately flows through the diode 27 and the 5D into the batteries 2F and 2E so that voltage regenerated in the batteries 2F and 2E is increased. This results in the speed-up of reduction in the A-phase current I1a, in other words, the speed-up of removal of charges remaining in the transistors 51 and 24. As the mode in which regenerative electric power is returned to the batteries 2F and 2E, a mode in which the transistor 51 is turned off or the transistor 51 is turned on can be used.

Like the diode 5D, the overvoltage protective diode 5E allows an overvoltage applied when the transistor 52 is turned off with any one of the A-, B-, and C-phase currents flowing through a corresponding one of the motors M1, M2, and M3 to be transferred therethrough, resulting in protection of the transistor 52, and serves to speed up the removal of current (charges) from the transistor 52 and any one of the transistors 24 to 26. Similarly, the overvoltage protective diode 5F allows an overvoltage applied when the transistor 53 is turned off with any one of the A-, B-, and C-phase currents flowing through a corresponding one of the motors M1, M2, and M3 to be transferred therethrough, resulting in protection of the transistor 53, and serves to speed up the removal of current (charges) from the transistor 53 and any one of the transistors 24 to 26.

In the same manner as the coils 54 to 56 of the motor M1, in order to drive the motor M2, the driver DR supplies a drive signal to the gate of the transistor 52 to turn it on with the transistors 51 and 53 being off, resulting in that DC power is supplied through the power supply line SL and the transistor 52 to the motor M2. How to specifically supply current to the motor M2 has been described in the first embodiment. Similarly, in order to drive the motor M3, the driver DR supplies a drive signal to the gate of the transistor 53 to turn it on with the transistors 51 and 52 being off, resulting in that DC power is supplied through the power supply line SL and the transistor 53 to the motor M3. How to specifically supply current to the motor M3 has been described in the first embodiment.

Note that a main function of the transistors 51 to 53 as the N power supplies ST is to selectively drive any one of the motors M1 to M3. Thus, relay contacts, mechanical contacts of switches, or another type of power semiconductors, such as thyristors, can be used in place of the transistors 51 to 53.

As described above, the motor system illustrated in FIG. 5 according to the second embodiment is configured to share the transistors 24 to 26, the current sensors 5G, 5H, and 5J, and the diodes 27 to 29 among the three motors M1 to M3 to thereby reduce the number of elements in the motor system (drive circuit CC1). For example, in view of the number of transistors to be used, the drive circuit illustrated in FIG. 20 requires 18 transistors for driving three brushless motors, but the drive circuit CC1 illustrated in FIG. 5 requires six transistors for driving the three motors M1 to M3. Thus, as compared with the motor system illustrated in FIG. 20, it is possible to reduce the number of transistors in the drive circuit CC1 illustrated in FIG. 5 so that it is one-third the number of transistors used in the drive circuit illustrated in FIG. 20. This achieves the reduction in cost and size of the motor system according to the second embodiment. The reduction in the number of transistors in the drive circuit CC1 eliminates the use of a driving element for the transistors to be reduced, a power source for the driving element, and peripheral circuits around the transistors to be reduced, which are required to drive them, resulting in the further reduction in cost and size of the motor system according to the second embodiment.

If each of the motors M1 to M3 and the drive circuit CC1 are arranged to be separated from each other, it is important to focus on the number of wires that connect between each of the motors M1 to M3 and the drive circuit CC1 in view of cost. The motor system illustrated in FIG. 20 requires nine wires for connection between each of three brushless motors and the drive circuit, but the motor system illustrated in FIG. 5 requires six wires including three A-, B-, and C-phase wires for the motors M1, M2, and M3, a common wire for the motor M1, a common wire for the motor M2, and a common wire for the motor M3. Thus, as compared with the motor system illustrated in FIG. 20, it is possible to reduce the number of wires for connection between each of the three motors and the drive circuit.

For drive of four or more DC driven motors using the drive circuit CC1 illustrated in FIG. 5, only providing: at least one DC driven motor to be connected to the transistors 24 to 26 through the common wires; and a control circuit including a transistor as a power supplier, and an overvoltage protective diode in the motor system illustrated in FIG. 5 (see the arrow 5K) allows a desired number of DC driven motors to be added to the motor system illustrated in FIG. 5, making it possible to more reduce the cost of the motor system per motor.

Motor vehicles each use a plurality of motors (tiny motors) for attitude control of the door mirrors, attitude control of the driver's seat, control of an air conditioner, and the like. For attitude control of each of the left and right door mirrors, a motor for adjustment of the angle of the door mirror in the vertical direction, a motor for adjustment of the angle of the door mirror in the horizontal direction, and a motor for folding the door mirror are normally used. Thus, the total of six motors are used for attribute control of the door mirrors in each motor-vehicle. For attribute control of the driver's seat, motors for control of rotation of the driver's seat back and fourth, for control of tilt of the driver's seat, for control of the position of the driver's seat in the vertical direction, for reclining control of the driver's seat, and the like are used in each motor vehicle. Recently, a motor can be used for function of massaging the driver by the driver's seat. For control of an air conditioner, a motor for a blower for blowing air, a motor for switching outside air and inside air, a motor for control of warm air and cool air, and a motor for control of the location of air to be blown out are used. As described above, many motors are used for motor vehicles.

As motor systems including such a large number of motors and a drive circuit for driving them, the motor system according to the second embodiment illustrated in FIG. 5 can be used for reduction in cost and size of the motor system. As described later, the motor system according to the second embodiment illustrated in FIG. 5 can be applied to a main machine for driving motor vehicles, and the drive circuit according to the second embodiment illustrated in FIG. 5 can drive simultaneously at least two of the motors.

### Third Embodiment

A motor system according to the third embodiment of the present disclosure will be described hereinafter with reference to FIG. 6.

The motor system illustrated in FIG. 6 includes two motors M4 and M5 driven on DC power, for example, each of which is designed as the motor 110. The motor system also includes a drive circuit CC2 for driving the two motors M4 and M5.

The structure and/or functions of the drive circuit CC2 according to the third embodiment are different from the drive circuit CC1 by the following points. So, the different points will be mainly described hereinafter.

The motor M4 includes three coils W5A, W5B, and W5C corresponding to the A-, B-, and C-phase coils 21, 22, and 23, respectively, through which a unidirectional current, that is, a DC current is supplied to flow. Similarly, the motor M6 includes three coils W6A, W6B, and W6C corresponding to the A-, B-, and C-phase coils 21, 22, and 23, respectively, through which a unidirectional current, that is, a DC current is supplied to flow.

Each of reference characters 61, 62, 63, 71, 72, and 73 represents any one of the coils W5A, W5B, W5C, W6A, W6B, and W6C.

Reference characters 64, 65, and 66 represent bipolar transistors (transistors). The collector of each of the transistors 64 to 66 is connected to a power supply line PL1 connected to the positive terminal of the battery 2F, and the emitter of each of the transistors 64 to 66 is connected to one end of a corresponding one of the coils 61, 62, and 63. The one end of each of the coils 61 to 63 is connected to the power supply line SL. One end of each of the coils 71 to 73 is connected to the power supply line SL, and the other end of each of the coils 71 to 73 is connected to the collector of a corresponding one of the transistors 24 to 26. The emitter of each of the transistors 24 to 26 is connected to the negative terminal of the battery 2E. The base (conduction control terminal) of each of the transistors 64 to 66 is connected to the driver DR (connections therebetween are not illustrated in FIG. 6 for simplicity of descriptions).

The diodes 27 to 29 are provided for the transistors 24 to 26, respectively. The cathode of each of the diodes 27 to 29 is connected to the power supply line SL1, and the anode of each of the diodes 27 to 29 is connected to a connecting point between the emitter of a corresponding one of the transistors 24 to 26 and a corresponding one of the coils 71 to 73. The diodes 67 to 69 are provided for the transistors 64 to 66, respectively. The anode of each of the diodes 67 to 69 is connected to the negative terminal of the battery 2E, and the cathode of each of the diodes 67 to 69 is connected to a connecting point between the emitter of a corresponding one of the transistors 64 to 66 and a corresponding one of the coils 61 to 63.

The driver DR and the transistors 24 to 26 energize the coils 71 to 73. For example, the driver DR supplies a drive signal to the gate of the transistor 24 to turn it, resulting in that DC power is supplied through the power supply line SL and the transistor 24 to the coil 71, thus energizing the coil 71. How to specifically supply current to the coil 71 has been described in the first embodiment. Similarly, the driver DR and the transistors 25 and 26 can energize the coils 72 and 73.

In addition, when the transistors 24 to 26 are switched from on state to off state, the diodes 27, 28, and 29 allow corresponding phase currents to flow to the battery 2F based on regenerative electric energy (magnetic energy) charged in the corresponding coils, respectively, resulting in that the battery 2F is charged.

The driver DR and the transistors 64 to 66 energize the coils 61 to 63. For example, the driver DR supplies a drive signal to the gate of the transistor 64 to turn it, resulting in that DC power is supplied through the power supply line SL1 and the transistor 64 to the coil 61, thus energizing the coil 61. Similarly, the driver DR and the transistors 65 and 66 can energize the coils 62 and 63.

In addition, when the transistors 64 to 66 are switched from on state to off state, the diodes 67, 68, and 69 allow corresponding phase currents to flow to the battery 2E based on regenerative electric energy charged in the corresponding coils, respectively, resulting in that the battery 2E is charged.

As described above, the drive circuit CC2 according to the third embodiment is configured to balance consumption of power from the battery 2E and the battery 2F, and charge of regenerative power into the battery 2E and the battery 2F. Thus, the drive circuit CC2 eliminates the use of the DC to DC converter illustrated in FIG. 2, or reduces the burden on the DC to DC converter, thus reducing the drive circuit CC2 in cost.

Each of the coils W5A, W5B, W5C, W6A, W6B, and W6C of the motors M4 and M5 can be allocated for a corresponding one of the coils 61, 62, 63, 71, 72, and 73. Thus, it is preferable that the coils W5A, W5B, W5C, W6A, W6B, and W6C of the motors M4 and M5 are arranged to use the batteries 2E and 2F with good balance therebetween.

For drive of three or more DC driven motors using the drive circuit CC2 illustrated in FIG. 6, only providing: at least one DC driven motor (coil), at least one transistor is connected in parallel to at least one of the batteries 2E and 2F, and a diode connected to the at least one transistor (see the arrows 6B and 6C) allows a desired number of DC driven motors to be added to the motor system illustrated in FIG. 6, making it possible to more reduce the cost of the motor system per motor.

### Fourth Embodiment

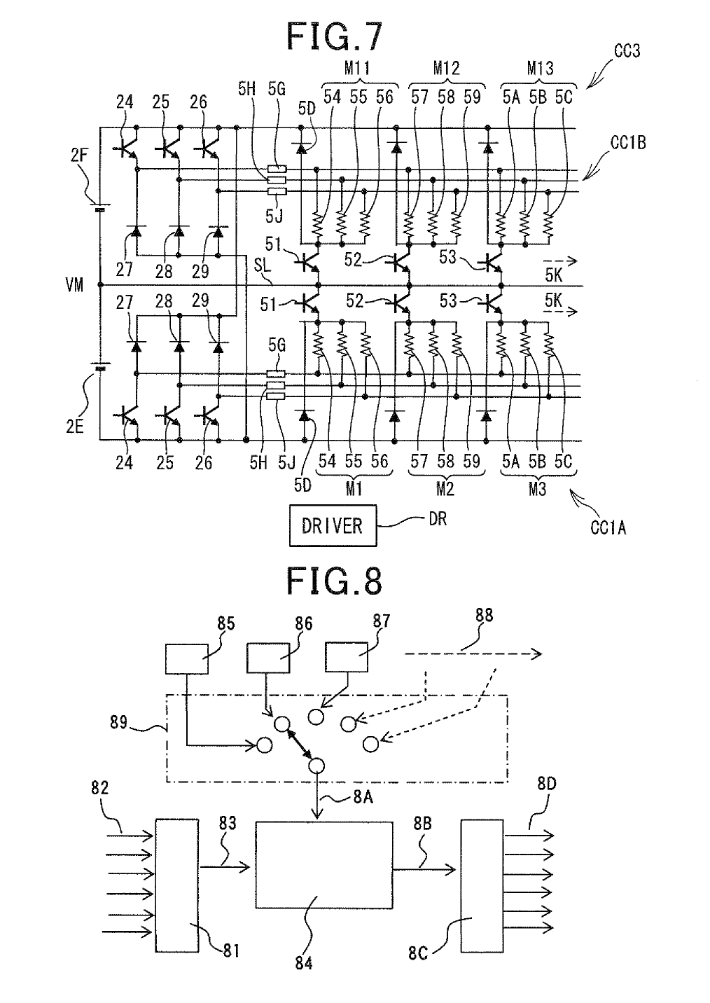

A motor system according to the fourth embodiment of the present disclosure will be described hereinafter with reference to FIG. 7.

The motor system illustrated in FIG. 7 includes six motors M1 to M3 and M11 to M13 driven on DC power, for example, each of which is designed as the motor 110. The motor system also includes a drive circuit CC3 for driving the six motors M1 to M3 and M11 to M16.

The structure and/or functions of the drive circuit CC3 according to the fourth embodiment are different from the drive circuit CC1 according to the second embodiment by the following points. So, the different points will be mainly described hereinafter.

As illustrated in FIG. 7, the drive circuit CC3 includes a first drive circuit CC1A, which has the same structure as the drive circuit CC1, provided for the battery 2E, and a second drive circuit CC1B provided for the battery 2F and having a symmetrical structure to the first drive circuit CC1A with respect to the power supply line SL. The motor M11 includes three coils 54, 55, and 56 corresponding to the A-, B-, and C-phase coils 21, 22, and 23, respectively, through which a unidirectional current, that is, a DC current is supplied to flow. Specifically, the coil 54 is comprised of the positive and negative A-phase windings 1D and 1G, the coil 55 is comprised of the positive and negative B-phase windings 1F and 1J, and the coil 56 is comprised of the positive and negative C-phase windings 1H and 1E. Similarly, the motor M12 includes three coils 57, 58, and 59 corresponding to the A-, B-, and C-phase coils 21, 22, and 23, respectively, and the motor M13 includes three coils 5A, 5B, and 5C corresponding to the A-, B-, and C-phase coils 21, 22, and 23, respectively.

The number of motors to be driven by each of the first and second drive circuits CC1A and CC1B can be desirably selected.

Note that a shunt resistor, a current transformer for measuring current, a current sensor using a hall element, or a current sensor using a magnetic resistive element can be used as each of the current sensors 5G, 5H, and 5J illustrated in FIGS. 5 and 7. Shunt resistors have disadvantages of heat due to their temperature coefficients and power consumption, and of their sizes. Current transformers have a disadvantage of their sizes. Current sensors using a hall element have disadvantages of their zero-point offsets, heat due to their temperature coefficients, and noise, and, similarly, current sensors using a magnetic resistive element have disadvantages of their zero-point offsets, heat due to their temperature coefficients, and noise. For these reasons, current sensors are very expensive and large in size.

In view of this, the motor system illustrated in each of FIGS. 5 and 7 is configured to share the current sensors 5G, 5H, and 5J among a plurality of motors to be driven, making it possible to reduce the motor system in cost and size.

### Fifth Embodiment

The fifth embodiment of the present disclosure schematically illustrates specific operations (functional elements) of the driver DR of the drive circuit CC1 to drive the three motors M1 to M3 with reference to FIG. 8.

Reference character 81 represents an information input means (section) to which instructions 82 for controlling a motor as a target motor MX to be controlled are entered. The instructions 82 include ID information of the target motor, and target value of controlled variables of the target motor, such as a target RPM of the target motor MX, and a target output torque thereof. The information input means 81 is operative to input, to the driver DR, the entered instructions 83.

Reference character 85 represents a memory in which a first set of motor parameters (control parameters) including the ratio of the RPM of the motor M1, gain constants for control, and so on, are stored beforehand. Similarly, reference character 86 represents a memory in which a second set of motor parameters including the ratio of the RPM of the motor M2, gain constants for control, and so on are stored beforehand, and reference character 87 represents a memory in which a third set of motor parameters including the ratio of the RPM of the motor M3, gain constants for control, and so on are stored beforehand.

Reference character 89 represents a parameter selecting means (section) that selects one of the first to third sets of motor parameters corresponding to the target motor MX, and supplies, to a processing unit 84, the selected set 8A of motor parameters corresponding to the target motor MX.

The processing unit 84 is comprised of, for example, a microprocessor and/or logic circuits, and operative to calculate, based on the entered instructions 83 and the selected set 8A of motor parameters, a target current value and a target voltage value for each phase of the target motor MX, and calculate on and off timings for corresponding transistors required to drive the target motor MX so as to obtain the target current value and target voltage value for each phase of the target motor MX. Then, the processing unit 84 is operative to output, to an output section 8C, motor control information 8B indicative of the on and off timings for the corresponding transistors required to drive the target motor MX. The output section 8C is operative to output, to the corresponding transistors required to drive the target motor MX, drive signals 8D based on the on and off timings for the corresponding transistors required to drive the target motor MX. The drive signals include a drive signal to be applied to the gate of any one of the transistors 51, 52, and 53 corresponding to the target motor MX, and drive signals to be applied to ones of the transistors 24 to 26 corresponding to the target motor MX. This results in that the control circuit CC1 supplies currents, which meet the target current value and target voltage value for each phase of the target motor MX, to the coils of the target motor MX, thus adjusting actual values of the controlled variables of the target motor MX to be substantially in agreement with the entered target values of the controlled variables.

As described above, the driver DR of the control circuit CC1 according to the fifth embodiment is configured to, in order to drive the three motors M1, M2, and M3, select one of the motors M1, M2, and M3 to be driven, select the motor parameters of the selected motor MX, calculate information indicative of how to drive the selected motor MX, and drive transistors required to drive the selected motor MX to supply a corresponding current and voltage for each phase of the selected motor MX in accordance with the calculated information. As illustrated by the dashed arrow 88 in FIG. 8, the driver DR of the control circuit CC1 can drive four or more motors to be added in the same procedure as that illustrated in FIG. 8. Each of the control circuits CC, CC2, and CC3 can carry out the same procedure as that illustrated in FIG. 8 in order to drive a plurality of motors.

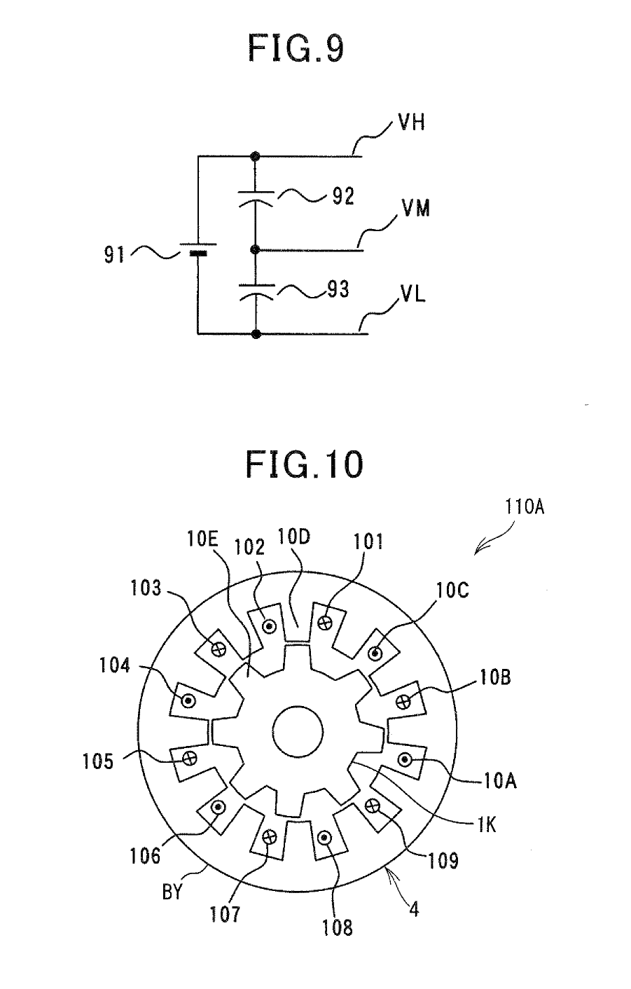

Note that, as the DC power sources 2E and 2F, batteries can be used, but various modifications can be applied to the DC power sources. Specifically, as at least one of the DC power sources 2E and 2F, a power supply circuit illustrated in FIG. 9 can be used. The power supply circuit includes a DC power source (battery) 91 and a pair of capacitors 92 and 93. The positive terminal of the battery 91 is connected to one electrode of the capacitor 92, and the other electrode of the capacitor 92 is connected to one electrode of the capacitor 93. The other electrode of the capacitor 93 is connected to the negative terminal of the battery 91. The power supply circuit is configured to generate, based on a voltage (potential) of the battery 91, three-different potentials including a potential VH, a potential VM, and a potential VL.

### Sixth Embodiment

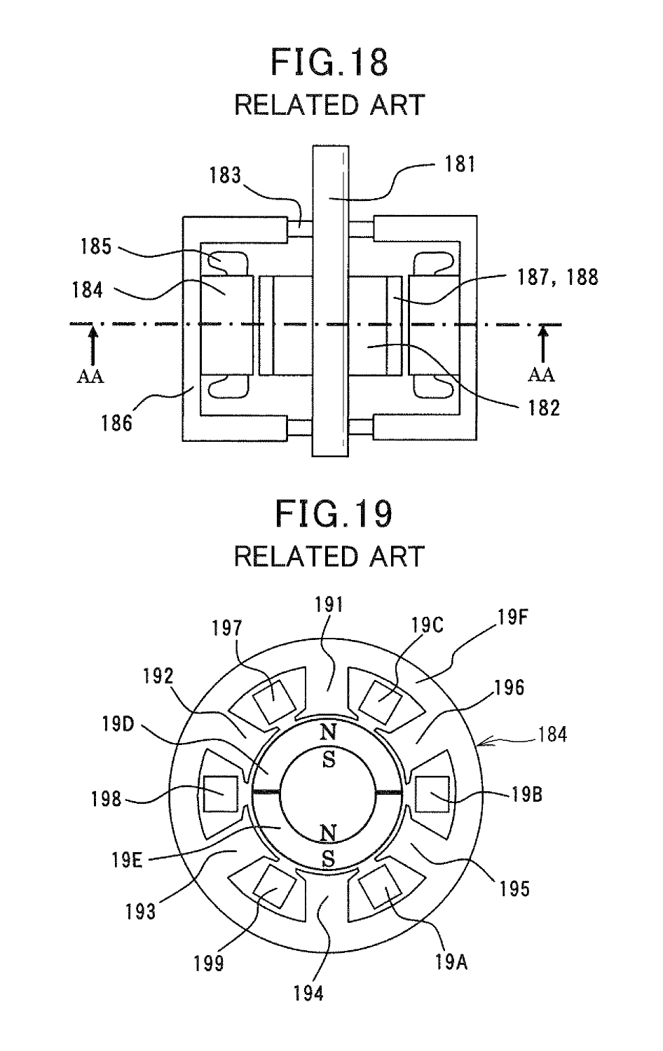

The sixth embodiment of the present disclosure schematically illustrates various examples of motors as modifications of the motor according to the first embodiment. The motor 110 illustrated in FIG. 18 and FIG. 3 is an example of many motors according to the present disclosure, and a motor 110A illustrated in FIG. 10 has the number of poles that is double of the number of poles of the motor 110 illustrated in FIG. 18 and FIG. 3.

For example, if a motor has the number M of salient poles of a stator and the number K of salient poles of a rotor, the motor is referred to as “MSKR motor”. For example, because the motor 110 has six salient poles of the stator 4 (M=6) and four salient poles of the rotor 2 (K=4) according to the first embodiment, the motor 110 is referred to as “6S4R motor 110”.

That is, the motor 110A is a 12S8R motor designed by expanding the 6S4R motor 110 to eight-pole motor. The stator is provided with twelve stator poles (the number M is twelve), which are represented by 10D. The rotor has a substantially annular shape, and has, at its outer circumference, with eight salient poles 10E.

Twelve stator coils 101, 102, 103, 104, 105, 106, 107, 108, 10A, 10B, and 10C are wound in the stator core (see circled dots and circled cross).

Specifically, the A-phase coils are represented by 101, 104, 107, and 10A whose current directions are each indicated by the circled cross or circled dot. The B-phase coils are represented by 103, 106, 109, and 10C whose current directions are each indicated by the circled cross or circled dot, and the C-phase coils are 105, 108, 10B, and 102 whose current directions are each indicated by the circled cross or circled dot. The motor 110A is driven such that a direct current (unidirectional current) is supplied to flow through each of the A-, B-, and C-phase coils in positive and negative directions indicated by circled cross and circled dot symbols illustrated in FIG. 10. The A-phase coils are wound in corresponding slots of the stator 4 at regular pitches of 180 electrical degrees. The actual length of each coil end of the A-phase coils corresponds to a mechanical angle of 90 degrees that is the half of the pitches of 180 electrical degrees of the A-phase coils. Each of the structures of the B-, and C-phase coils has the same structure as that of the A-phase coils. Multi-pole motors each having a number of rotor poles and a number of stator poles, which are more than three times the number of rotor poles and that of stator poles of the motor 110, can be obtained.

A motor 110E illustrated in FIG. 11 has the number of rotor poles that is the half of the number of rotor poles of the motor 110 illustrated in FIG. 1B and FIG. 3.

A two salient pole rotor, referred to simply as “rotor”, 11E has a substantially rectangular prism and a through hole at its center portion in its height direction. An axis passing the center portion of the rotor 11E in the height direction thereof will be referred to as “center axis” hereinafter.

The output shaft 1 is fixedly mounted on the inner surface of the through hole of the rotor 11E. The output shaft 1 is disposed in the opening of the motor housing 6 such that both ends thereof project from the opening, and the rotor 11E is installed in the motor housing 6. The output shaft 1 is rotatably supported by the motor housing 6 with the bearings 3.

The rotor 11E is made up of, for example, a plurality of magnetic silicon steel sheets, as an example of soft magnetic materials stacked in alignment. Similarly, the stator core 11F is made up of, for example, a plurality of magnetic silicon steel sheets, as an example of soft magnetic materials, stacked in alignment.

The stator core 11F is installed in the motor housing 6 such that its center axis is coaxial to the center axis of the rotor 11E and its inner circumference is opposite to a first pair of lateral sides LS and a second pair of longitudinal sides of the rotor 11E.

Each of the lateral sides LS of the first pair of the rotor 11E is outwardly rounded with a curvature identical to that of the inner circumference of the stator core 11F. Each of the lateral sides LS of the first pair of the rotor 11E is shorter than one of the longitudinal sides of the second pair thereof so that each of the lateral sides LS of the first pair projects from the center axis of the rotor 11E in comparison to the longitudinal sides of the second pair. This configuration provides two salient poles. Each of the lateral sides LS of the first pair of the rotor 11E is closely opposite to the inner surface of the stator core 11F with an air gap therebetween. The three-phase stator coils and the stator core constitute a stator.

Next, the structure of the stator will be fully described with reference to FIG. 11.

The stator core 11F consists of an annular back yoke BY and 6 teeth 117, 118, 119, 11A, 11B, and 11C projecting inwardly and circumferentially arranged at equal pitches therebetween. Each of the teeth 117, 118, 119, 11A, 11B, and 11C serves as a salient pole. The inner surface of each of the teeth (salient poles) has a concavely circumferentially rounded shape with a curvature identical to that of the outer surface of each of the salient poles of the rotor 11E. Spaces between circumferentially adjacent teeth provide 6 slots of the stator core 11F.

As each of three-phase stator coils of the motor illustrated in FIG. 11, a concentrated, full pitch winding is used.

An A-phase coil 111 and 114 is concentrically wound in a slot between the teeth 11C and 117 and in a slot between the teeth 119 and 11A. A dashed line connecting between the A-phase coil 111 and 114 represents a winding path of an end of the A-phase coil 111 and 114. A B-phase coil 113 and 116 is concentrically wound in a slot between the teeth 118 and 119 and in a slot between the teeth 11B and 11C. A dashed line connecting between the B-phase coil 113 and 116 represents a winding path of an end of the B-phase coil 113 and 116. A C-phase coil 115 and 112 is concentrically wound in a slot between the teeth 11A and 11B and in a slot between the teeth 117 and 118. A dashed line connecting between the C-phase coil 115 and 112 represents a winding path of an end of the C-phase coil 115 and 112.

Each of the coil ends is arranged over a corresponding one half part of the back yoke BY, but can be arranged over each half part of the back yoke BY.

The motor 110B is driven such that a direct current is supplied to flow through each of the A-, B-, and C-phase coils in positive and negative directions indicated by circled cross and circled dot symbols illustrated in FIG. 11. The positive direction represents a direction into the paper of FIG. 11, and the negative direction represents a direction out of the paper of FIG. 11.

Specifically, a group of A-phase windings in the A-phase coil through which a direct current in the positive direction is defined as “a positive A-phase winding (111)”, and a group of A-phase windings in the A-phase coil through which a direct current in the negative direction flows is defined as “a negative A-phase winding (114)”.

Similarly, a group of B-phase windings in the B-phase coil through which a direct current in the positive direction is defined as “a positive B-phase winding (113)”, and a group of B-phase windings in the B-phase coil through which a direct current in the negative direction flows is defined as “a negative B-phase winding (114)”. In addition, a group of C-phase windings in the C-phase coil through which a direct current in the positive direction is defined as “a positive C-phase winding (115)”, and a group of C-phase windings in the C-phase coil through which a direct current in the negative direction flows is defined as “a negative C-phase winding (112)”.

Reference character Ht represents a circumferential electrical angular width of the inner surface of each of the teeth, and reference character Hs represents a circumferential electrical angular width of the innermost open end of each slot. Reference character Hm represents a circumferential electrical angular width of each of the lateral sides of the rotor 11E, in other words, each of the salient poles of the rotor 11E.

Each of the angular width Ht and the angular width Hm can be set to, for example, 60 electrical degrees; this obtains continuous torque to be generated by the motor 110B. If the angular width Hs of the innermost open end of each slot were excessively short, leakage flux between adjacent stator poles would be increased. A present rotational position of the rotor 11E is represented by θr relative to a reference position R illustrated in FIG. 1B. The reference position is a line passing through the center of the slot between the teeth 11C and 117, the center axis of the rotor 11E, and the center of the slot between the teeth 119 and 11A.

As illustrated in FIG. 11, because the rotor 11E has the two-pole salient structure, a space 11D is formed between each of the longitudinal sides of the rotor 11E and a corresponding inner surface of the stator core 11F opposite thereto. Note that, in order to reduce winding loss when the motor illustrated in FIG. 11 is rotated at a high RPM, the rotor can be formed with a nonmagnetic member. The nonmagnetic member can be mounted on each of the longitudinal sides of the rotor 11E in the space 11D to provide a substantially circular shape of the rotor 11E in its lateral cross section with an air gap between the nonmagnetic member and the inner surface of the stator core 11F opposite thereto. As a material for the nonmagnetic member, a material having a low conductivity can be preferably used in order to reduce eddy current.

When each salient pole of the rotor 11E is shifted to be close to the opening end of a corresponding one slot, a magnetic flux density acting to generate torque is reduced so that a magnetic attractive force therebetween is reduced to generate torque ripples. One approach to reduce the torque ripples is that the rotor 11E or the stator 11F is skewed in its circumferential direction. The rotor 11E or the stator 11F can be stepwisely skewed.

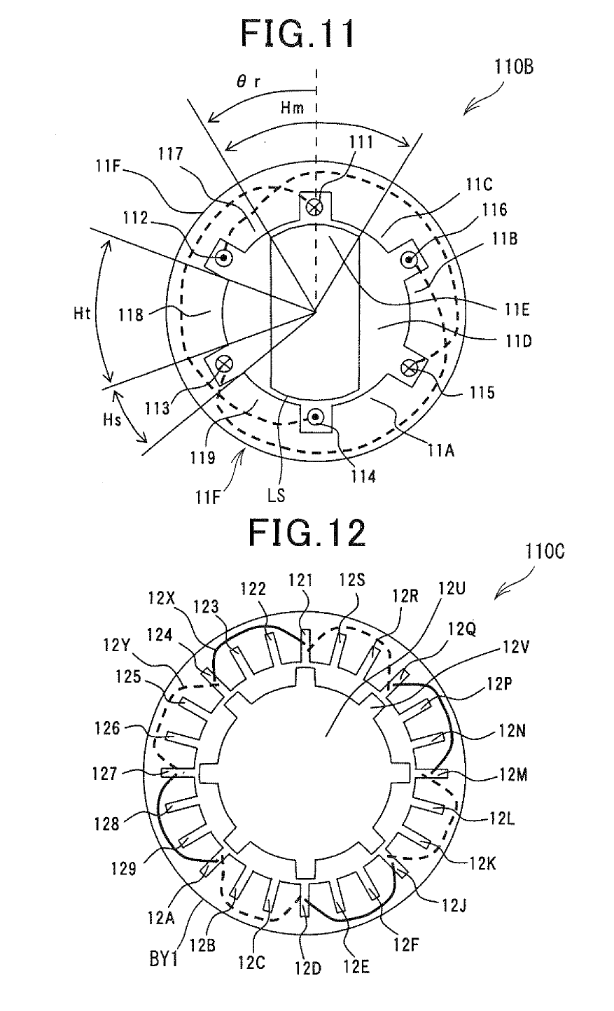

A motor 110C illustrated in FIG. 12 has the number of rotor poles that is the four times greater than the number of rotor poles of the motor 110B illustrated in FIG. 11. Specifically, FIG. 12 schematically illustrates an example of eight-pole motor. The eight-pole motor illustrated in FIG. 12 includes a rotor 12U and a stator core 12T different from the rotor 11E and the stator 11F of the two-pole motor illustrated in FIG. 11.

Specifically, the rotor 12U has a substantially annular shape, and has, at its outer circumferential surface, eight salient poles 12V. The eight salient poles 12V are circumferentially arranged at regular pitches.

The stator core 12T consists of an annular back yoke BY1 and 24 teeth. The teeth project inwardly and are circumferentially arranged at equal pitches therebetween. Each of the teeth serves as a salient pole. Spaces between circumferentially adjacent teeth provide 24 slots 121, 122, 123, 124, 125, 126, 127, 128, 129, 12A, 12B, 12C, 12D, 12E, 12F, 12J, 12K, 12L, 12M, 12P, 12Q, 12R, and 12S of the stator core 12T.

The slots 121, 124, 127, 12A, 12D, 12J, 12M, and 12Q are used for the A-phase coil. The A-phase coil is wound in these slots in, for example, wave winding or distributed winding. Reference characters 12C and 12Y represent coil ends of the A-phase coil. The slots 123, 126, 129, 12C, 12F, 12L, 12P, and 12S are used for the B-phase coil. The B-phase coil is wound in these slots in, for example, wave winding or distributed winding. The slots 125, 128, 12B, 12E, 12K, 12N, 12R, and 122 are used for the C-phase coil. The C-phase coil is wound in these slots in, for example, wave winding or distributed winding. As illustrated in FIG. 12, the motor 110B illustrated in FIG. 11 can be designed as a multi-pole motor with shorter coil ends and a thinner thickness of its back yoke. This reduces such a multi-pole motor in its size and weight as compared with the motor 110B.

As described above, the motor systems according to the present disclosure illustrated in FIGS. 1A, 1B, 2, 5, 6, 11, and the like reduce their inverters in cost and size. Additional characteristics achieved by the motor system according to the present disclosure will be described hereinafter.

The motor 110 illustrated in FIGS. 1A and 1B uses no rare-earth magnets, and therefore, has a lower cost than a cost of motors using such rare-earth magnets. This at least slightly contributes to the depletion of resources, such as rare-earth magnets, and to the rise in the price of such rare-earth magnets.

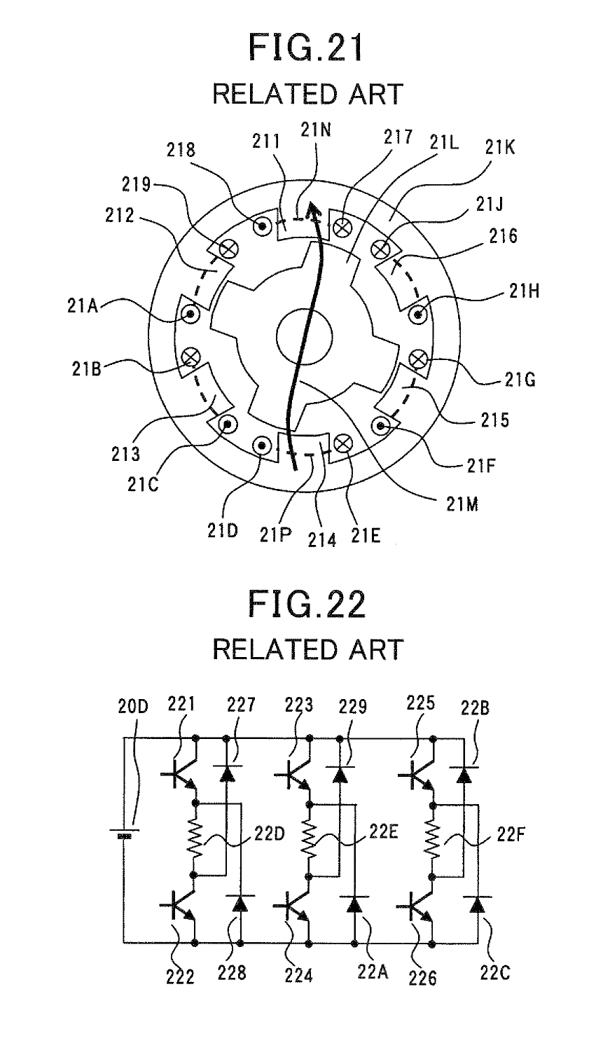

In addition, the number of stator windings disposed in each slot according to the reluctance motor 110 is the half of that of stator windings disposed in each slot of the switched reluctance motor illustrated in FIG. 21. Thus, it is possible to increase the thickness of each stator winding of the reluctance motor 110 to the twice of that of each stator winding of the switched reluctance motor illustrated in FIG. 21. It is preferable to reduce the length of ends each stator coil of the reluctance motor 110.

Because the rotor 2 of the motor 110 is made up of, for example, a plurality of magnetic silicon steel sheets, the rotor 2 is rugged. This makes it easy to physically use a higher RPM of the rotor 2, thus increasing the output of the reluctance motor 110 to a high level.

As described above, the reluctance motor 110 illustrated in FIG. 1B uses the magnetic attractive force between each stator pole and a corresponding one rotor pole to thereby create a torque for turning the rotor 2. Thus, it is possible to use a simple torque-generation principle, making it easy to achieve the torque characteristics of the reluctance motor 110 with relatively low ripples. This allows the reluctance motor 110 to be lower in vibration and noise. Note that rapid variations in the attractive force in the radial directions of the rotor may cause the stator core to vibrate.

The reluctance motor 110 has no permanent magnets so that no magnetic fluxes are generated inside the reluctance motor 110 while the stator windings are unexcited. This achieves an important feature to prevent, during the reluctance motor 110 being rotated together with the output shaft 1, unnecessary iron loss mostly attractive to drag torque from occurring. That is, in hybrid motors, electric motors, and the like, there is a problem that the unnecessary iron loss may occur during a conventional permanent magnet motor being rotated together with the output shaft at a higher RPM.

Each of the stator coils illustrated in a corresponding one of FIGS. 1B and 11 is so formed in a lap winding as to be convolutedly wound in corresponding paired slots to provide overlapped loop portions.

Each of the stator coils illustrated in a corresponding one of FIGS. 1B and 11 can be so formed in a wave winding or in a ring winding. Because a unidirectional current is supplied to flow through each stator winding to generate a unidirectional magnetic flux from each stator pole, a filed winding can be additionally provided in each stator pole. A small salient pole can be mounted on each salient pole of each of the motors 110 and 110B illustrated in FIGS. 1B and 11 to make each tooth become multi-teeth, such as two teeth or three teeth.

Different sized two motors 110 or 110B illustrated in FIG. 1B or 11 are provided, and the two motors 110 or 110B can be concentrically arranged to provide a dual motor.

Specifically, the annular rotor of the large-sized motor is arranged outermost, and the annular stator of the large-sized motor is arranged to be opposite to the inner surface of the annular rotor of the large-sized motor. The annular stator of the small-sized motor is arranged such that its back yoke is opposite to the back yoke of the annular stator of the large-sized motor. The annular rotor of the small-sized motor is arranged to be opposite to the inner surface of the annular stator of the small-sized motor. The back yoke of the stator of the large-sized motor can be combined with that of the stator of the small-sized motor.

With the structure of the dual motor, each of A-, B-, and C-phase coils can be wound in corresponding slots of both stators of the large-sized and small-sized motors, making it possible to simplify the winding configuration of the dual motor.

As described above, the drive circuit illustrated in FIG. 2, 5, or 6 according to the present disclosure supplies A-, B-, and C-phase currents to the motor illustrated in FIG. 1B, FIG. 11, or the like to thereby drive it. At that time, the drive circuit illustrated in FIG. 2, 5, or 6 according to the present disclosure uses at least two power supply lines, and simultaneously supplies, via the at least two power supply lines, two-phase currents in the A-, B-, and C-phase currents to the motor illustrated in FIG. 1B, FIG. 11, or the like. For example, the drive circuit CC illustrated in FIG. 2 supplies power to two coils in the three-phase coils through corresponding two power supply lines. For this reason, the drive circuit CC illustrated in FIG. 2 can supply power expressed by “C×V×2” to the motor illustrated in FIG. 1B, FIG. 11, or the like, as compared with the drive circuit illustrated in FIG. 20, which can supply power expressed by “C×V×1”; reference character C represents current capacity, and V represents voltage of the power source. That is, the drive circuit CC illustrated in FIG. 2 can supply, to the motor illustrated in FIG. 1B, FIG. 11, or the like, power that is double of power that can be supplied from the drive circuit illustrated in FIG. 20 to the motor illustrated in FIG. 1B, FIG. 11, or the like.

Conditions that the drive circuit illustrated in FIG. 2, 5, or 6 according to the present disclosure can supply power to a motor through at least two power supply lines include:

the first condition is that a current to be supplied to each phase winding is a unidirectional current (direct current);

the second condition is that stator windings of the motor are wound such that the unidirectional current to be supplied to each stator winding is individually controlled; and

the third condition is that the unidirectional current flowing through a positive or negative stator winding excites, in two torque generation modes, two stator poles disposed circumferentially adjacent to the positive or negative stator winding when each of the two stator poles creates a torque, in other words, each positive or negative stator winding is shared by the two torque generation modes.

The technical effects to be achieved by the drive circuit illustrated in FIG. 2, 5, or 6 can be achieved if a motor is configured such that its stator winding is wound in a wave winding, an annular field winding is added to each stator pole, each tooth is made multi-teeth, or its structure is the dual motor.

### Seventh Embodiment

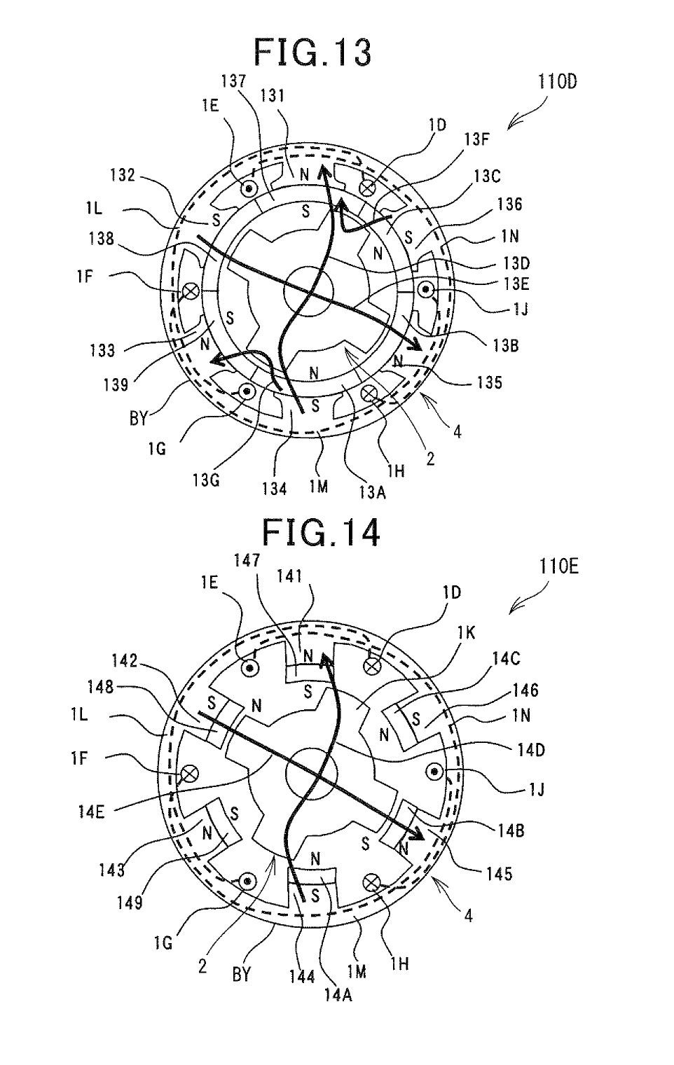

The seventh embodiment of the present disclosure schematically shows three examples of motors including permanent magnets each located at the surface or inside of a stator pole with reference to FIGS. 13 to 15. The motors illustrated in FIG. 1B and FIG. 11 are reluctance motors without using permanent magnets. Such a reluctance motor is inexpensive because of no permanent magnets. Such a reluctance motor requires generation of magnetomotive force using current. Tiny reluctance motors each with a diameter of 100 mm or less require relatively large current to generate magnetomotive force. This may cause lower torque to be generated by the such tiny reluctance motors as compared with permanent-magnet motors.

FIG. 13 schematically illustrates an example of the structure of a reluctance motor 110D according to the seventh embodiment of the present disclosure.

In addition to the structure of the motor 110 illustrated in FIG. 1B as a basic structure, the reluctance motor 110D includes a plurality of permanent magnets 137, 138, 139, 13A, 13B, and 13C. The plurality of permanent magnets 137, 138, 139, 13A, 13B, and 13C are mounted on the inner surfaces of stator poles 131, 132, 133, 134, 135, and 136 corresponding to the stator poles 11, 12, 13, 14, 15, and 16, respectively. Each of the plurality of permanent magnets 137, 138, 139, 13A, 13B, and 13C has a concavely circumferentially rounded shape with a curvature identical to that of the inner surface of each of the stator poles 131, 132, 133, 134, 135, and 136. The plurality of permanent magnets 137, 138, 139, 13A, 13B, and 13C are circumferentially contacted to one another to form a substantially ring shape.

The rotor 2 is arranged such that its outer circumference is opposite to an inner circumference of the ring-shaped permanent magnets 137, 138, 139, 13A, 13B, and 13C with an air gap therebetween.

As well as the first embodiment, the drive circuit CC is operative to supply an A-phase direct current Ia to the A-phase coil 1D and 1G in the direction indicated by the circled cross and circled dot, and a B-phase direct current Ib to the B-phase coil 1F and 1J in the direction indicated by the circled cross and circled dot. In addition, the drive circuit CC is operative to supply a C-phase direct current Ic to the C-phase coil 1H and 1E in the direction indicated by the circled cross and circled dot.

A direction of a magnetic flux to be created by each of the permanent magnets 137, 138, 139, 13A, 13B, and 13C is illustrated by reference characters “N” and “S” in FIG. 13. Specifically, the direction of a magnetic flux to be created by each of the permanent magnets 137, 138, 139, 13A, 13B, and 13C is matched with a direction of a magnetic flux to be created by a corresponding one stator pole when two stator windings disposed at its both circumferential sides are energized.

That is, the motor 110D is designed such that:

each of the stator poles is excited by a unidirectional current flowing each of two phase stator windings located at its both circumferential sides of a corresponding one of the stator poles to thereby create a unidirectional magnetic flux by each of the excited stator poles.

The design of the motor 110D allows the permanent magnets 137, 138, 139, 13A, 13B, and 13C to be mounted on the stator poles 131, 132, 133, 134, 135, and 136, respectively.

As illustrated in FIG. 13, during the rotor 2 being rotated in the counterclockwise direction, when one salient pole of the rotor 2 faces both the permanent magnets 137 and 13C, four magnetic fluxes 13D, 13E, 13F, and 13G are induced. Specifically, the magnetic flux 13D is induced based on the permanent magnets 13A and 137 from the stator pole 134 to the stator pole 131, and the magnetic flux 13E is induced based on the permanent magnets 138 and 135 from the stator pole 132 to the stator pole 135. In addition, the magnetic flux 13F is induced based on the permanent magnets 13C and 137 from the permanent magnet 13C to the permanent magnet 137, and the magnetic flux 13G is induced based on the permanent magnets 13A and 139 from the permanent magnet 13A to the permanent magnet 139.

These magnetic fluxes 13D, 13E, 13F, and 13G are changed depending on the rotation of the rotor 2.

In order to prevent demagnetization of each permanent magnet due to improper control of the motor 110D, each permanent magnet can be designed such that it can be magnetized by a corresponding one phase winding. Under proper current control of the motor 110D set forth above, each of the permanent magnets is not demagnetized.

Specifically, the motor 110D illustrated in FIG. 13 achieves the following features that eliminate the need of exciting current because of the permanent magnets 137, 138, 139, 13A, 13B, and 13C, increase torque to be outputted, and reduce the current capacitance of each transistor for supplying a corresponding phase current. This results in an increase in the motor efficiency, a reduction in the current capacitance of the drive circuit, and a reduction in size of the motor 110D. In addition, this results in a reduction in the inductance of each phase stator coil and a reduction in the change in the inductance depending on the rotating position of the rotor, making it possible to reduce the rate of change in the motor parameters, facilitating the controllability of the motor 110D.

FIG. 14 schematically illustrates an example of the structure of a reluctance motor 110E according to the seventh embodiment of the present disclosure.

In addition to the structure of the motor 110 illustrated in FIG. 1B as a basic structure, the reluctance motor 110E includes a plurality of permanent magnets 147, 148, 149, 14A, 14B, and 14C. The plurality of permanent magnets 147, 148, 149, 14A, 14B, and 14C are mounted on the inner surfaces of stator poles 141, 142, 143, 144, 145, and 146 corresponding to the stator poles 11, 12, 13, 14, 15, and 16, respectively. Each of the plurality of permanent magnets 147, 148, 149, 14A, 14B, and 14C has a concavely circumferentially rounded shape with a curvature identical to that of the inner surface of each of the stator poles 141, 142, 143, 144, 145, and 146. Each of the permanent magnets 147, 148, 149, 14A, 14B, and 14C has an inner surface whose circumferential width is shorter than that of each of the permanent magnets 137, 138, 139, 13A, 13B, and 13C.

The rotor 2 is arranged such that its outer circumference is opposite to an inner circumference of the stator core 4 with an air gap therebetween.

The influence of a unidirectional current to be supplied to each of the three-phase coils on the characteristic curve of each of the permanent magnets 141 to 14A is substantially identical to that as with the reluctance motor 110D illustrated in FIG. 13.

A direction of a magnetic flux to be created by each of the permanent magnets 147, 148, 149, 14A, 14B, and 14C is illustrated by reference characters “N” and “S” in FIG. 14. Specifically, the direction of a magnetic flux to be created by each of the permanent magnets 147, 148, 149, 14A, 14B, and 14C is matched with a direction of a magnetic flux to be created by a corresponding one stator pole when two stator windings disposed at its both circumferential sides are energized.

As illustrated in FIG. 14, during the rotor 2 being rotated in the counterclockwise direction, when one salient pole of the rotor 2 faces a space between the permanent magnets 147 and 14C, two magnetic fluxes 14D and 14E are induced. Specifically, the magnetic flux 14D is induced based on the permanent magnets 14A and 147 from the stator pole 144 to the stator pole 141, and the magnetic flux 14E is induced based on the permanent magnets 148 and 14B from the stator pole 142 to the stator pole 145. These magnetic fluxes 14D and 14E are changed depending on the rotation of the rotor 2.

In order to crate a torque in the CCW at the rotational position of the rotor 2 illustrated in FIG. 13, an A-phase current Ia with a preset level is supplied to flow through the A-phase coil 1D and 1G. At the same time, a C-phase current Ic with the same preset level is supplied to flow through the C-phase coil 1H and 1E. This causes magnetomotive force to increase the magnetic flux 14D while keeping the magnetic flux 14E unchanged.

As described above, adjusting the circumferential width of each of permanent magnets mounted on the inner surface of a corresponding one of the stator poles can achieve various motor characteristics.

Note that, regarding the shape of each permanent magnet described above, some of the permanent magnets can be greater in thickness than the remaining thereof; this makes different the magnetic characteristics of some of the permanent magnets and those of the remaining of the permanent magnets. As the permanent magnets, rare-earth magnets, cast magnets, ferrite magnets, bond magnets composed of the combination of a magnet and a resin, and combinations of them can be used according to the purpose of using the motor 110D or 110E.

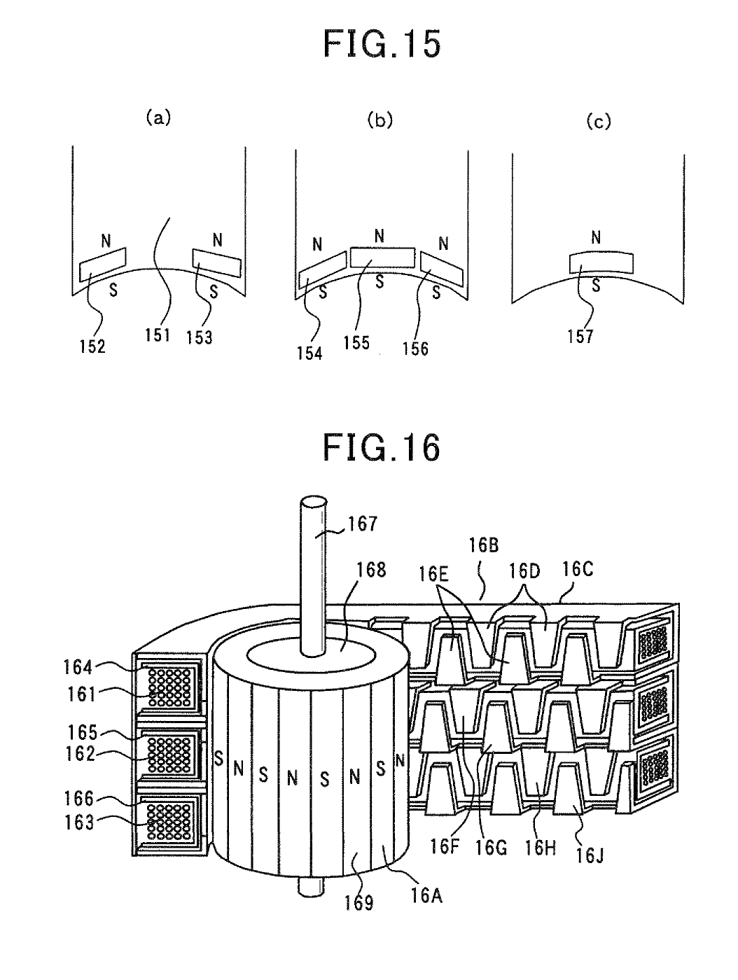

Each of (a), (b), and (c) of FIG. 15 illustrates, for example, a stator pole of the motor 110E in an enlarged scale; reference character 151 is assigned to this stator pole. (a) of FIG. 15 illustrates two permanent magnets 152 and 153 embedded in both circumferential edges of one end of the stator pole 151 opposing the rotor, and (b) of FIG. 15 illustrates three permanent magnets 154, 155, and 156 so embedded in the one end of the stator pole 151 as to be circumferentially aligned along the inner surface of the one end of the stator pole 151. (c) of FIG. 15 illustrates a permanent magnet 157 embedded in the one end of the stator pole 151 at the circumferentially center portion of the one end thereof. The permanent magnet 157 can be embedded in the one end of the stator pole 151 at one circumferential edge of the one end thereof.

### Eighth Embodiment

The eighth embodiment of the present disclosure shows an application of the drive circuit illustrated in FIG. 2, FIG. 5, FIG. 6, or FIG. 7 for drive of a stepping motor having looped three-phase coils by supplying three-phase direct currents Ia, Ib, and Ic to the three looped coils, respectively.

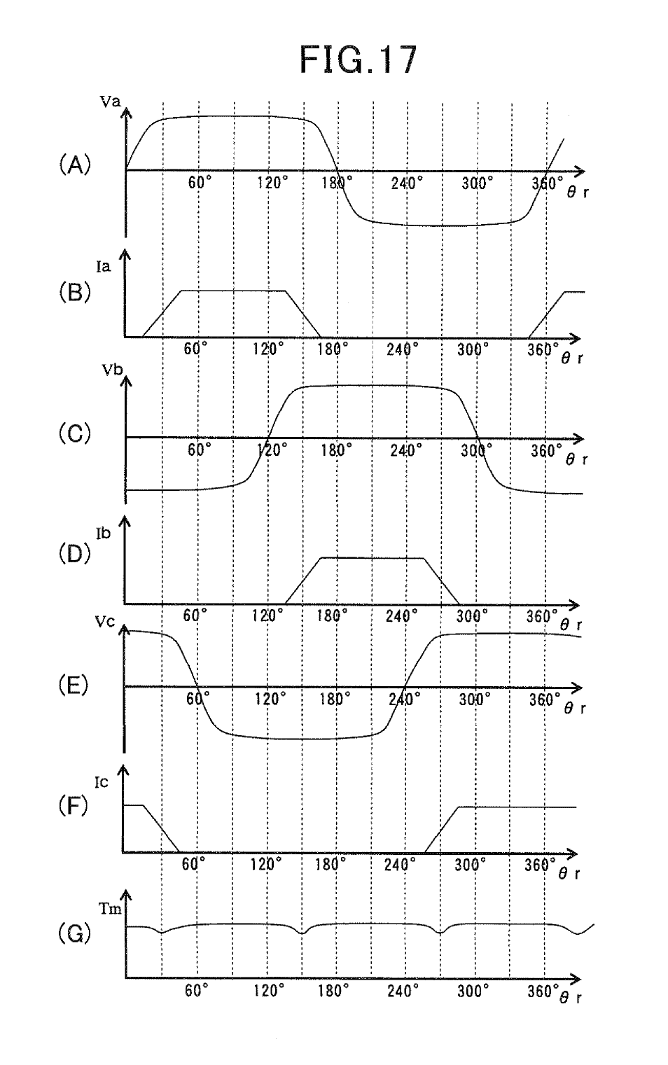

Referring to FIG. 16, reference character 169 represents N-pole magnets, and reference character 16A represents S-pole magnets. The N-pole and S-pole magnets 169 and 16A are mounted on an outer surface of a cylindrical rotor such that the N-pole and S-pole magnets 169 and 16A are alternately arranged in the circumferential direction of the rotor. Reference character 168 represents a back yoke of the rotor, and reference character 167 represents a rotor shaft corresponding to a center axis of the rotor. Reference character 16B represents an annular stator concentrically arranged around the rotor with an air gap therebetween. A substantially quarter part of the stator 16B is illustrated at a corresponding normal location, and the remaining part of the stator 16B is linearly expanded in order to illustrate the structure of the stator 16B.

Reference characters 164, 165, and 166 represent annular bobbins of the stator 16B that are arranged around the rotor and layered in an axial direction of the rotor shaft 167. Reference characters 161, 162, and 163 represent the looped three-phase coils that are wound in the annular bobbins 164, 165, and 166, respectively.

Reference characters 16D and 16E represent positive A-phase poles and negative A-phase poles, respectively. Each of the positive A-phase poles 16D has a phase difference of 180 electrical degrees relative to a corresponding one of the negative A-phase poles 16E. Reference characters 16F and 16G represent positive B-phase poles and negative B-phase poles, respectively. Each of the positive B-phase poles 16F has a phase difference of 180 electrical degrees relative to a corresponding one of the negative B-phase poles 16G. Reference characters 16H and 16J represent positive C-phase poles and negative C-phase poles, respectively. Each of the positive C-phase poles 16H has a phase difference of 180 electrical degrees relative to a corresponding one of the negative C-phase poles 16J. Reference character 16C represents an annular back yoke of the stator 16B.

When the stepping motor illustrated in FIG. 16 is turned at a given RPM, voltages Va, Vb, and Vc across the three-phase coils 161, 162, and 163 are illustrated in (A), (C), and (E) of FIG. 17, respectively. Supplying direct currents Ia, Ib, and lc as illustrated in (B), (D), and (E) of FIG. 17 to the A-, B-, and C-phase coils 161, 162, and 163 allows a substantially constant continuous torque Tm to be obtained as illustrated in (G) of FIG. 17. The drive circuit illustrated in FIG. 5, FIG. 6, or FIG. 7 can drive a plurality of stepping motors each having the structure illustrated in FIG. 16, making it possible to provide a motor system comprised of the plurality of stepping motors and the drive circuit illustrated in FIG. 5, FIG. 6, or FIG. 7.

### Ninth Embodiment

The ninth embodiment of the present disclosure shows an application of the drive circuit illustrated in FIG. 5, FIG. 6, or FIG. 7 for drive of the switched reluctance motor illustrated in FIG. 21 set forth above.

The drive circuit illustrated in FIG. 5, FIG. 6, or FIG. 7 switchably supplies dc currents to the A-, B-, and C-phase coils such that one pair of salient poles of the rotor 21L and the other pair of salient poles of the rotor 21K are alternately attracted from a corresponding pair of opposing teeth of the stator 21K, resulting in continuous rotation of the rotor 21L. Thus, it is possible to provide an inexpensive motor system comprised of the switched reluctance motor illustrated in FIG. 21 and the drive circuit illustrated in FIG. 5, FIG. 6, or FIG. 7.

### Tenth Embodiment

The tenth embodiment of the present disclosure shows an application of the drive circuit illustrated in FIG. 5, FIG. 6, or FIG. 7 for drive of the brushless motor illustrated in FIGS. 18 and 19 set forth above.

When the brushless motor illustrated in FIG. 19 is turned at a given RPM, voltages Vu, Vv, and Vw across the U-phase winding 197 and 19A, the V-phase winding 199 and 19C, and the W-phase winding 19B and 198 are identical to the voltages Va, Vb, and Vc illustrated in (A), (C), and (E) of FIG. 17, respectively. Supplying direct currents Ia, Ib, and Ic as illustrated in (B), (D), and (E) of FIG. 17 to the U-phase winding 197 and 19A, the V-phase winding 199 and 19C, and the W-phase winding 19B and 198 allows a substantially constant continuous torque Tm to be obtained as illustrated in (G) of FIG. 17. The drive circuit illustrated in FIG. 5, FIG. 6, or FIG. 7 can drive a plurality of stepping motors each having the structure illustrated in FIG. 19, making it possible to provide a motor system comprised of the plurality of brushless motors and the drive circuit illustrated in FIG. 5, FIG. 6, or FIG. 7. Note that a plurality of wires including three U-, V-, and W-phase wires for the plurality of brushless motors and a plurality of common wires for the respective brushless motors are used to connect the drive circuit FIG. 5, FIG. 6, or FIG. 7 and the plurality of brushless motors.

### Eleventh Embodiment

The eleventh embodiment of the present disclosure shows how to specifically drive one of the three motors M1 to M3 by the drive circuit CC1 illustrated in FIG. 5 and the driver DR of the drive circuit CC 1 illustrated in FIG. 8.

In order to carry out: control of a current to be supplied to each phase coil using pulse-width modulation (PWM) at a frequency of 20 kHz, and speed control at a frequency of 1 kHz, a specific approach based on sampling control of the single motor M1 is to execute the speed control at a cycle Tv of 1 millisecond, and execute the PWM current control at a cycle Ti of 0.05 milliseconds, that is, 20 times, during execution of each speed control. The specific approach repeats one set of the speed control and the PWM current control set forth above to thereby control voltages, currents, and speed of the motor M1.

Specifically, the drive circuit CC1 carries out PWM control of the transistors 24 to 26 at 20 kHz with the transistor 51 being on to thereby control each phase current and each phase voltage.

### Twelfth Embodiment

The twelfth embodiment of the present disclosure shows how to drive parallely at least two of the three motors M1 to M3 by the drive circuit CC1 illustrated in FIG. 5 and the driver DR of the drive circuit CC1 illustrated in FIG. 8.

The drive circuit CC1 is configured to turn on the transistor 51 for the motor M1, and carry out PWM control of the motor M1 at a cycle Ti of 0.05 milliseconds, that is, 10 times, with the transistor 51 being on while executing speed control of the motor M1 in the fast half of each cycle Tv of 1 millisecond, thus supplying currents and voltages to the coils 54, 55, and 56 of the motor M1.

The drive circuit CC1 is also configured to turn off the transistor 51, turn on the transistor 52 for the motor M2, and carry out PWM control of the motor M2 at the cycle Ti of 0.05 milliseconds, that is, 10 times, with the transistor 52 being on while executing speed control of the motor M2 in the latter half of each cycle Tv of 1 millisecond, thus supplying currents and voltages to the coils 57, 58, and 59 of the motor M2. At that time, torque of a motor depends on current to be supplied thereto. Speed of each of the motors M1 to M3 can be calculated using an equation of motion. This shows that speed of each of the motors M1 to M3 includes time-derivative term of torque. Thus, each of the motors M1 to M3 can be idly rotated for a given short time.

Using these characteristics of each of the motors M1 to M3 allows the drive circuit CC1 to carry out time-division control of each of the motors M1 and M2 by: dividing each cycle into a plurality of time sections, controlling voltage, current, and torque of the motor M1 within some of the plurality of time sections, and controlling voltage, current, and torque of the motor M2 within the remaining time sections.

Note that the speed control of each of the motors M1 and M2 is carried out by the processing unit 84 using the motor parameters of a motor to be controlled, which are selected by the parameter selecting means 89. In the same manner as control of the motors M1 and M2, the drive circuit CC1 can carry out time-division control of each of the motors M1 to M3.

As described above, the drive circuit CC1 achieves speed control of a plurality of motors in parallel with each other by carrying out time-division control of voltage, current, and torque of each of the plurality of motors set forth above.

If a motor Mm is rotated in most time zones, and an alter native motor Ms is rotated temporarily, it is possible to consider that the alternative motor Ms can be driven using the drive circuit CC1 for the motor Mm. For individual control of four wheels of a motor vehicle, a first drive circuit illustrated in FIG. 5, FIG. 6, or FIG. 7 can be designed to individually control a first pair of motors for two wheels, and a second drive circuit illustrated in FIG. 5, FIG. 6, or FIG. 7 can be designed to individually control a second pair of motors for the remaining two wheels. Particularly, for stable driving of motor vehicles on snowy roads, the same output and the same torque for each of the four wheels are not necessarily required. The motor system including the first and second drive circuits set forth above can achieve control of only one of the first pair of motors for two wheels and the second pair of motors for the remaining two wheels if four-wheel-drive is not required. For example, a motor system can be configured to include a first drive circuit illustrated in FIG. 5, FIG. 6, or FIG. 7 for individually controlling a pair of main motors, and a second drive circuit illustrated in FIG. 5, FIG. 6, or FIG. 7 for individually controlling a pair of auxiliary motors.

As described above, the present disclosure provides the various types of motor systems including a plurality of motors; these motor systems each have a low cost and a compact size. The various types of motor system can be modified or applied to another motor system.

Specifically, each of the various types of motor systems can include a plurality of motors each is an outer-rotor motor, an axial gap motor, a liner motor, or a motor designed by combining plural types of motors. each of the various types of motor system can include a plurality of motors including a dc motor. If the motors M1 to M3 include a dc motor, a diode can be provided for each of the transistors 24 to 26, which allows the transistors 24 to 26 to be driven in parallel with each other. The motors illustrated in FIGS. 1 and 11 can be developed to multi-phase motors including four-phase, five-phase, and six-phase motors.

The shape of current and/or voltage to be applied to each phase winding of a motor can be deformed. For example, an additional component can be superimposed on current and/or voltage to be applied to each phase winding of a motor. Control of a motor based on the rotor position can be carried out using an encoder for measuring the rotor position. Control of a motor based on the rotor position can be carried out without using sensors for measuring the rotor position and/or for measuring the rotational speed of the rotor. The drive circuits according to the present disclosure can be modified or applied to another drive circuit. A drive circuit with a microprocessor, a drive circuit without using microprocessors, or a drive circuit in which a driver and a power circuit is packaged can be used as one of the drive circuits according to the present disclosure.

As described above, each of the motor systems according to the present disclosure is comprised of a plurality of DC driven motors and a drive circuit part of which is shared for the plurality of DC driven motors. This configuration reduces each of the motor systems in cost, size, and weight. In addition, the drive circuit is able to select at least one of the plurality of motors, and drive it with its speed, torque, and/or rotor position being controlled. The drive circuit is also adapted to control the speed, torque and/or rotor position of each of the plurality of motors in parallel. Each of the motor systems according to the present invention can include DC motors as the plurality of DC driven motors.

Many motors are used in motor vehicles and home electronics, and therefore, there is a great need for reduction in cost, size, and weight of motor systems. Each of the motor systems according to the present disclosure is adapted to meet such a great need.

While illustrative embodiments of the present disclosure have been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be constructed as non-exclusive.

What is claimed is:

1. A system comprising:
a plurality of motors, each of the plurality of motors having a plurality of phase windings, each of the plurality of motors being rotated when a unidirectional current is supplied to each of the plurality of phase windings thereof;
a motor select unit comprising a plurality of selectors connected to the plurality of motors, respectively, the motor select unit being configured to select at least one of the plurality of motors via a corresponding at least one of the selectors; and
a phase current supplier connected in series to each of the plurality of selectors and configured to supply a direct current as the unidirectional current to each of the plurality of phase windings of the selected at least one of the plurality of motors via a corresponding at least one of the selectors.

2. A system comprising:
first and second motors, the first and second motors having a plurality of phase windings, the first and second motors being rotated when a unidirectional current is supplied to the plurality of phase windings thereof;
a first DC power source;
a second DC power source connected to the first DC power source in series;
a plurality of transistors, each of the plurality of phase windings of the first and second motors being connected to any one of the first and second DC power sources via a corresponding one of the plurality of transistors;
a plurality of diodes connected antiparallel to the plurality of transistors, respectively; and
a driver connected to each of the plurality of transistors and configured to:
turn on a corresponding one of the plurality of transistors to supply, from a corresponding one of the first and second DC power sources, a direct current as the unidirectional current to one of the plurality of phase windings of the first and second motors; and
turn off the corresponding one of the plurality of transistors to transfer magnetic energy charged in the one of the plurality of phase windings to the corresponding one of the first and second DC power sources via a corresponding one of the plurality of diodes.

3. The system according to claim 1, further comprising:
a plurality of current sensors provided respectively in a plurality of paths between the phase current supplier and the plurality of selectors, each of the plurality of current sensors being configured to measure the direct current being supplied to a corresponding one of the plurality of phase windings of each of the plurality of motors.

4. The system according to claim 1, wherein the motor select unit is configured to select the at least one of the plurality of motors via the corresponding at least one of the selectors according to a motor selection signal indicative of the at least one of the plurality of motors, further comprising:
a parameter selecting unit configured to select, according to the motor selection signal, at least one control parameter for the at least one of the plurality of motors from a plurality of control parameters for the plurality of motors,
the phase current supplier being configured to control how to supply the direct current as the unidirectional current to each of the plurality of phase windings of the selected at least one of the plurality of motors based on the selected at least one control parameter.

5. The system according to claim 1, wherein the plurality of motors includes a motor comprising:
a stator provided with a number J (J is an integer equal to or greater than 6) of first poles within 360 electrical degrees at spaces therebetween, the plurality of phase windings of the motor at least partly wound in the spaces, respectively, with pitches of 180 electrical degrees therebetween; and
a rotor arranged relative to the stator and provided with a number K (K is an integer equal to or greater than 2) of second pole.

6. The system according to claim 2, wherein the first and second motors include a motor comprising:
a stator provided with a number J (J is an integer equal to or greater than 6) of first poles within 360 electrical degrees at spaces therebetween;
a number of phase windings as part of the plurality of phase windings of the first and second motors, the number of the phase windings being at least partly wound in the spaces, respectively, with pitches of 180 electrical degrees therebetween; and
a rotor arranged relative to the stator and provided with a number K (K is an integer equal to or greater than 2) of second poles.

7. The system according to claim 1, wherein the plurality of motors includes a motor comprising:
a stator provided with a number P (P is an integer equal to or greater than 6) of first poles within 360 electrical degrees at spaces therebetween, each of the plurality of phase windings of the motor wound around a corresponding one of the first poles; and
a rotor arranged relative to the stator and provided with a number Q (Q is an integer equal to or greater than 4) of second poles.

8. The system according to claim 2, wherein the first and second motors include a motor comprising:
a stator provided with a number P (P is an integer equal to or greater than 6) of first poles within 360 electrical degrees at spaces therebetween;
a number of phase windings as part of the plurality of phase windings of the first and second motors, each of the number of the phase windings being wound around a corresponding one of the first poles; and
a rotor arranged relative to the stator and provided with a number Q (Q is an integer equal to or greater than 4) of the second poles.

9. The system according to claim 1, wherein the plurality of motors includes a stepping motor, the stepping motor being rotated when a direct current is supplied as the unidirectional current to each of the plurality of phase windings thereof.

10. The system according to claim 2, wherein the first and second motors include a stepping motor comprising a number of phase windings as part of the plurality of phase windings of the first and second motors, the stepping motor being rotated when a direct current is supplied as the unidirectional current to each of the number of the phase windings.

11. The system according to claim 1, wherein the plurality of motors includes a brushless motor comprising a rotor to which at least one permanent magnet is provided, the brushless motor being rotated when a direct current is supplied as the unidirectional current to each of the plurality of phase windings thereof.

12. The system according to claim 2, wherein the first and second motors include a brushless motor comprising a rotor to which at least one permanent magnet is provided, and a number of phase windings as part of the plurality of phase windings of the first and second motors, the brushless motor being rotated when a direct current is supplied as the unidirectional current to each of the number of the phase windings.

13. The system according to claim 1, wherein a time to be used for control of the plurality of motors is divided into a sequence of time sections, the time sections are allocated for the plurality of motors, respectively, further comprising:
a driver configured to control, within each of the plurality of time sections, the direct current to be supplied to a corresponding one of the plurality of motors, the corresponding one of the plurality of motors being selected by the motor select unit, resulting in that the plurality of motors are controlled substantially in parallel within the time.
